(19) United States
(12) Patent Application Publication
(10) Pub. No.: US 2026/0371111 A1
(43) Pub. Date: Nov. 19, 2026

(54) COMMUNICATION CONTROL METHOD AND APPARATUS

(71) Applicant: BEIJING XIAOMI MOBILE SOFTWARE CO., LTD., Beijing (CN)

(72) Inventor: Yumin WU, Beijing (CN)

(73) Assignee: BEIJING XIAOMI MOBILE SOFTWARE CO., LTD., Beijing (CN)

(21) Appl. No.: 19/470,932

(22) PCT Filed: Apr. 6, 2023
(86) PCT No.: PCT/CN2023/086747

§ 371 Date: Sep. 30, 2025

(51) Int. Cl. H04W 24/02; H04W 36/36; H04W 36/38; H04W 76/19

(52) U.S. Cl. CPC H04W 24/02; H04W 36/362; H04W 36/38; H04W 76/19

(57) ABSTRACT

A communication control method, performed by a terminal, including: receiving first information sent by a network device. The first information indicates an association relationship between second information and third information, the second information indicates a configuration of at least one candidate cell, and the third information indicates a manner for processing a first communication entity.

### CROSS-REFERENCE TO RELATED APPLICATIONS

This application is a US National Phase application of International Application No. PCT/CN 2023/086747 filed on Apr. 6, 2023, the entire contents of which are incorporated herein by reference.

### TECHNICAL FIELD

The present disclosure relates to the field of communication technologies, and in particular to a communication control method and apparatus, a communication device, a communication system, and a storage medium.

### BACKGROUND

In a communication system, a network device may control a terminal to change multiple candidate cells (or cell groups) through a Layer 1 (L1) or Layer 2 (L2) signaling. This procedure may be referred to as an L1/L2-triggered Mobility (LTM) procedure.

### SUMMARY

According to a first aspect of embodiments of the present disclosure, a communication control method is provided. The method includes:
receiving first information sent by a network device, in which the first information indicates an association relationship between second information and third information, the second information indicates a configuration of at least one candidate cell, and the third information indicates a manner for processing a first communication entity.
According to a second aspect of embodiments of the present disclosure, a communication control method is provided. The method includes:
sending first information is sent to a terminal, in which the first information indicates an association relationship between second information and third information, the second information indicates a configuration of at least one candidate cell, and the third information indicates a manner for processing a first communication entity.

According to a third aspect of embodiments of the present disclosure, a terminal is provided. The terminal includes:
at least one processor, and a memory storing instructions executable by the at least one processor. The at least one processor is configured to: receive first information sent by a network device, in which the first information indicates an association relationship between second information and third information, the second information indicates a configuration of at least one candidate cell, and the third information indicates a manner for processing a first communication entity.

According to a fourth aspect of embodiments of the present disclosure, a network device is provided. The device includes:
at least one processor, and a memory storing instructions executable by the at least one processor. The at least one processor is configured to perform the method described above in the second aspect.

### BRIEF DESCRIPTION OF THE DRAWINGS

The above and/or additional aspects and advantages of the present disclosure will become apparent and readily understood from the following description of the embodiments in conjunction with the accompanying drawings.

FIG. 1 is a schematic diagram of an architecture of some communication systems provided by the embodiments of the present disclosure.

FIG. 2 is an interaction diagram of a communication control method applicable to a communication system provided by an embodiment of the present disclosure.

FIG. 3a is a flowchart of a communication control method applicable to a terminal provided in an embodiment of the present disclosure.

FIG. 3b is a flowchart of a communication control method provided in an embodiment of the present disclosure.

FIG. 3c is a flowchart of a communication control method provided in an embodiment of the present disclosure.

FIG. 3d is a flowchart of a communication control method provided in an embodiment of the present disclosure.

FIG. 3e is a flowchart of a communication control method provided in an embodiment of the present disclosure.

FIG. 3f is a flowchart of a communication control method provided in an embodiment of the present disclosure.

FIG. 4a is flowchart of a communication control method applicable to a network device provided in an embodiment of the present disclosure.

FIG. 4b is flowchart of a communication control method provided in an embodiment of the present disclosure.

FIG. 4c is flowchart of a communication control method provided in an embodiment of the present disclosure.

FIG. 5 is a flow chart of a communication control method applicable to a communication system provided in an embodiment of the present disclosure.

FIG. 6a is a schematic structural diagram of a first communication control apparatus provided in an embodiment of the present disclosure.

FIG. 6b is a schematic structural diagram of a second communication control apparatus provided in an embodiment of the present disclosure.

FIG. 7a is a schematic structural diagram of a communication device provided in an embodiment of the present disclosure.

FIG. 7b is a schematic structural diagram of a chip provided in an embodiment of the present disclosure.

### DETAILED DESCRIPTION

A method of the present disclosure can be used to solve the technical problem of how to save a control signaling for controlling a communication entity when a terminal performs a dynamic cell (or cell group) change.

Embodiments of the present disclosure provide a communication control method and apparatus, a communication device, a communication system, and a storage medium.

In a first aspect, the embodiments of the present disclosure provide a communication control method. The method includes:
receiving first information sent by a network device, in which the first information indicates an association relationship between second information and third information, the second information indicates a configuration of at least one candidate cell, and the third information indicates a manner for processing a first communication entity.

In the above embodiments, the terminal can receive the first information sent by the network device so that the terminal can obtain the correspondence relationship between the configuration of the candidate cell and the manner for processing the communication entity, thereby determining whether the manner for processing the communication entity needs to be changed when the dynamic cell changes, saving the terminal's control signaling for the specific control of the communication entity.

In combination with some embodiments of the first aspect, in some embodiments, the method further includes:
receiving fourth information sent by the network device, where the fourth information indicates a configuration of a first cell and/or a second cell corresponding to the terminal; and determining third information corresponding to the fourth information based on the fourth information and the first information,.

In the above embodiments, there is provided the method for the terminal to determine the manner for processing the communication entity corresponding to the dynamic cell change, thereby ensuring that each dynamic cell change has a corresponding communication entity processing manner.

In combination with some embodiments of the first aspect, in some embodiments, determining, based on the fourth information and the first information, the third information corresponding to the fourth information includes:
determining whether fifth information corresponding to the fourth information exists based on the first information, in which the fifth information indicates a configuration group associated with the third information; and determining the third information based on the fifth information in response to the fifth information existing.

In the above embodiments, an indication mode of the communication entity is determined by determining whether the configuration indication information of the first cell and the second cell is in the configuration group indication information, thereby saving the control signaling for the terminal to control the communication entity in the preset manner.

In combination with some embodiments of the first aspect, in some embodiments, determining whether the fifth information corresponding to the fourth information exists based on the first information includes: in response to the configuration of at least one of the first cell or the second cell belongs to the fifth information, determining the fifth information corresponding to the fourth information exists.

In the above embodiments, it is determined whether indication information of the configuration of the first cell and of the configuration of the second cell belongs to configuration group indication information. If so, the manner for controlling the communication entity for the first cell and the second cell is determined by the communication entity control manner corresponding to the configuration group, thereby realizing the control of the communication entity through the pre-configuration manner when the terminal performs the dynamic cell change, thereby saving the control signaling.

In combination with some embodiments of the first aspect, in some embodiments, when the configuration of at least one of the first cell or the second cell belongs to the fifth information, determining the fifth information corresponding to the fourth information exists includes at least one of:
determining seventh information, the seventh information being fifth information corresponding to the first cell; or
determining eighth information, the eighth information being fifth information corresponding to the second cell, where the seventh information and the eighth information are the same or different

In the above embodiments, the relationship between the configurations of the first cell and the second cell and the fifth information is provided, which establishes a foundation for the terminal to determine the communication entity control manner.

In combination with some embodiments of the first aspect, in some embodiments, the first communication entity is processed based on third information corresponding to the fourth information.

In the above embodiments, the terminal controls the communication entity through the indication information of the control manner corresponding to the configurations of the first cell and the second cell, thereby saving the control signaling for controlling the communication entity when the terminal performs the dynamic cell (or cell group) change.

In combination with some embodiments of the first aspect, in some embodiments, processing the first communication entity based on the third information corresponding to the fourth information includes:

processing the first communication entity based on the third information corresponding to the fifth information, in response to at least the configuration of the second cell belonging to the fifth information.

In the above embodiments, through determining that the second cell belongs to the fifth information, the manner for the terminal to process the communication entity is determined, and the manner for the terminal to process the communication entity when the dynamic cell (cell group) changes is stipulated, thereby saving the control signaling for controlling the communication entity.

In combination with some embodiments of the first aspect, in some embodiments, the method further includes: in response to the fifth information not existing, determining the third information based on a protocol agreement

In the above embodiments, when the first cell and the second cell configuration indication identifiers do not belong to the configuration group indication information, the terminal processes the communication entity through the predefined protocol, thereby saving the control signaling for the terminal to control the communication entity.

In combination with some embodiments of the first aspect, in some embodiments, determining the third information corresponding to the fourth information based on the fourth information and the first information further includes:
receiving sixth information sent by the network device, where the sixth information indicates a mobility usage of the terminal; and
determining the third information corresponding to the fourth information based on the fourth information and the first information, in response to the sixth information meeting a first condition,.

In the above embodiments, the terminal mobility usage is determined, and then the indication information of the communication entity control mode corresponding to the first cell and second cell configuration indication information is determined.

In combination with some embodiments of the first aspect, in some embodiments, the first condition includes at least one of:
the terminal performing cell handover based on a signaling of the network device; or
the terminal performing cell handover in response to meeting a triggering condition configured by the network device or a triggering condition stipulated in a protocol agreement.

In the above embodiments, the first condition includes at least one of: the terminal performing the cell handover based on the signaling of the network device; or the terminal performing the cell handover when the triggering condition configured by the network device or the triggering condition stipulated in the protocol agreement is met, and by defining the first condition, the mobility usage of the terminal is determined.

In combination with some embodiments of the first aspect, in some embodiments, the second information includes at least one of:
a configuration identifier of the at least one candidate cell; or
a candidate cell identifier.

In combination with some embodiments of the first aspect, in some embodiments, the third information includes at least one of:
indication information on whether to reset or partially reset a media access control (MAC) entity;
indication information on whether to re-establish a radio link control (RLC) entity;
indication information on whether to re-establish a packet data convergence protocol (PDCP) entity; or
indication information on whether to recovery a PDCP entity.

In a second aspect, the embodiments of the present disclosure provide a communication control method. The method includes:
sending first information to a terminal, in which the first information indicates an association relationship between second information and third information, the second information indicates a configuration of at least one candidate cell, and the third information indicates a manner for processing a first communication entity.

In the above embodiments, the network device can send the first information to the terminal so that the terminal can obtain the correspondence relationship between the configuration of the candidate cell and the manner for processing the communication entity, thereby determining whether the manner for processing the communication entity needs to be changed when the dynamic cell changes, saving the terminal's control signaling for the specific control of the communication entity.

In combination with some embodiments of the second aspect, in some embodiments, the method further includes: sending fourth information to the terminal, in which the fourth information indicates a configuration of a first cell and/or a second cell corresponding to the terminal.

In combination with some embodiments of the second aspect, in some embodiments, the first information further includes fifth information, and the fifth information indicates a configuration group associated with the third information.

In combination with some embodiments of the second aspect, in some embodiments, the method further includes: sending sixth information to the terminal, in which the sixth information indicates a mobility usage of the terminal.

In combination with some embodiments of the second aspect, in some embodiments, the fifth information includes a configuration group identifier.

In combination with some embodiments of the second aspect, in some embodiments, the second information includes at least one of:
a configuration identifier of the at least one candidate cell; or
a candidate cell identifier.

In combination with some embodiments of the second aspect, in some embodiments, the third information includes at least one of:
indication information on whether to reset or partially reset an MAC entity;
indication information on whether to re-establish an RLC entity;
indication information on whether to re-establish a PDCP entity; or
indication information on whether to recovery a PDCP entity.

In a third aspect, the embodiments of the present disclosure provide a first communication control apparatus. The apparatus includes:
a receiving module, configured to receive first information sent by a network device, in which the first information indicates an association relationship between second information and third information, the second information indicates a configuration of at least one candidate cell, and the third information indicates the manner for processing a first communication entity.

In a fourth aspect, the embodiments of the present disclosure provide a second communication control apparatus. The apparatus includes:

a sending module, configured to send first information to a terminal, in which the first information indicates an association relationship between second information and third information, the second information indicates a configuration of at least one candidate cell, and the third information indicates a manner for processing a first communication entity.

In a fifth aspect, the embodiments of the present disclosure provide a communication device. The device includes: at least one processor; and at least one memory for storing instructions. The processor is configured to call the instructions to enable the communication device to perform the communication control method described in the first or second aspect, and the implementations of the first or second aspects.

In a sixth aspect, the embodiments of the present disclosure provide a communication system. The system includes a terminal and a network device. The terminal is configured to implement the method described in the first aspect and the implementations of the first aspect, and the network device is configured to implement the method described in the second aspect and the implementations of the second aspect.

In a seventh aspect, the embodiments of the present disclosure provide a storage medium storing instructions. When the instructions are executed on a communication device, the communication device is caused to perform the method described in the first aspect, the implementations of the first aspect, the second aspect, or the implementations of the second aspect.

In an eighth aspect, the embodiments of the present disclosure provide a program product. When the program product is executed by a communication device, the communication device performs the method described in the first aspect, the implementations of the first aspect, the second aspect, or the implementations of the second aspect.

In a ninth aspect, the embodiments of the present disclosure provide a computer program. When the computer program is executed on a computer, the computer is caused to perform the method described in the first aspect, the implementations of the first aspect, the second aspect, or the implementations of the second aspect.

It can be understood that the above-mentioned first communication control apparatus, second communication control apparatus, communication device, communication system, storage medium, program product, and computer program are all used to execute the method proposed in the embodiments of the present disclosure. Therefore, the achievable beneficial effects may refer to the beneficial effects in the corresponding methods, and will not be repeated here.

For the invention titles proposed in the present disclosure, in some embodiments, terms such as a communication control method, an information processing manner, and a communication method may be replaced with each other, terms such as an information transmission apparatus, an information processing apparatus, and a communication device may be replaced with each other, and terms such as an information processing system and a communication system may be replaced with each other.

The embodiments of the present disclosure are not exhaustive and are merely illustrative of some embodiments, and are not intended to limit the scope of protection of the present disclosure. In the absence of contradiction, each step in an embodiment may be implemented as an independent embodiment, and the steps may be arbitrarily combined. For example, a solution after removing some steps in a certain embodiment may also be implemented as an independent embodiment, and the order of the steps in a certain embodiment may be arbitrarily exchanged. In addition, the implementations in a certain embodiment may be arbitrarily combined. In addition, the embodiments may be arbitrarily combined. For example, some or all steps of different embodiments may be arbitrarily combined, and a certain embodiment may be arbitrarily combined with the implementations of other embodiments.

In each embodiment of the present disclosure, unless otherwise specified or provided for by logic, the terms and/or descriptions between the embodiments are consistent and may be referenced by each other. The technical features in different embodiments may be combined to form a new embodiment based on their inherent logical relationships.

The terms used in the embodiments of the present disclosure are only for the purpose of describing specific embodiments and are not intended to limit the present disclosure.

In the embodiments of the present disclosure, unless otherwise specified, elements expressed in the singular form, such as “a”, “an”, “the”, “above”, “said”, “aforementioned”, “this”, etc., may mean “one and only one”, or “one or more”, “at least one”, etc. For example, when using articles such as “a”, “an”, and “the” in English, a noun following the article may be understood as a singular expression or a plural expression.

In the embodiments of the present disclosure, “a plurality of” refers to two or more.

In some embodiments, the terms “at least one of”, “one or more”, “a plurality of”, “multiple”, etc. may be replaced with each other.

In the embodiments of the present disclosure, descriptions such as “at least one of A, B, C . . . ”, “A, B, and/or C . . . ”, etc. include the situation where any one of A, B, C . . . exists alone, and also include any combination of any multiple of A, B, C . . . , and each situation may exist alone. For example, “at least one of A, B, or C” includes the situation where A exists alone, B exists alone, C exists alone, the combination of A and B, the combination of A and C, the combination of B and C, and the combination of A, B, and C. For example, A and/or B includes the situation where A exists alone, B exists alone, and the combination of A and B.

In some embodiments, the expression such as “in a case where . . . , performing A, in another case where . . . , performing B”, “in response to a case . . . , performing A, in response to another case . . . , performing B”, etc. may include the following technical solutions according to the situations: performing A independently of B, that is, A is performed in some embodiments; executing B independently of A, that is, B is performed in some embodiments; selectively performing A or B, that is, A or B is selected for performing in some embodiments; performing both A and B, that is, A and B are performed in some embodiments. When there are more options such as A, B, C, the situations are similar as above.

The prefixes such as “first” and “second” in the embodiments of the present disclosure are only used to distinguish different description objects and do not constitute any restrictions on the position, order, priority, quantity or content of the description objects. For the statement of the description objects, please refer to the description in the context of the claims or embodiments, and no unnecessary restrictions should be constituted due to the use of prefixes. For example, if the description object is “field”, the ordinal number before “field” in “first field” and “second field” does not limit the position or order of the “fields”. The “first” and “second” do not limit whether the modified “fields” are in the same message, nor do they limit the order of the “first field” and “second field”. For another example, if the description object is “level”, the ordinal number before “level” in “first level” and “second level” does not limit the priorities of the “levels”. For another example, the numerical count of described objects is not limited by ordinal numbers and may be one or more. Taking “first apparatus” as an example, the numerical count of the “apparatus” may be one or more. In addition, the objects modified by different prefixes may be the same or different. For example, if the description object is “apparatus”, then the “first apparatus” and the “second apparatus” may be the same apparatus or different apparatuses, and their types may be the same or different. For another example, if the description object is “information”, then the “first information” and the “second information” may be the same information or different information, and their contents may be the same or different.

In some embodiments, “including A,” “comprising A,” “indicating A,” and “carrying A” may be interpreted as directly carrying A or indirectly indicating A.

In some embodiments, terms such as “in response to . . . ” , “in response to determining that . . . ”, “in a case of . . . ” , “at the time of . . . ” , “when . . . ” , “if . . . ” , etc. may be replaced with each other.

In some embodiments, terms such as “greater than”, “greater than or equal to”, “not less than”, “more than”, “more than or equal to”, “not less than”, “higher than”, “higher than or equal to”, “not less than”, and “above” may be replaced with each other, and terms such as “less than”, “less than or equal to”, “not greater than”, “smaller than”, “smaller than or equal to”, “not more than”, “lower than”, “lower than or equal to”, “not higher than”, and “below” may be replaced with each other.

In some embodiments, the apparatus, etc. may be interpreted as physical or virtual, and their names are not limited to the names recorded in the embodiments. Terms such as “device”, “equipment”, “device”, “circuit”, “network element”, “node”, “function”, “unit”, “section”, “system”, “network”, “chip”, “chip system”, “entity”, and “subject” may be replaced with each other.

In some embodiments, the terms “access network device (AN device)”, “radio access network device (RAN device)”, “base station (BS)”, “radio base station” “fixed station”, “node”, “access point”, “transmission point (TP)”, “reception point (RP)”, “transmission/reception point (TRP)”, “panel”, “antenna panel”, “antenna array”, “cell”, “macro cell”, “small cell”, “femto cell”, “pico cell”, “sector”, “cell group”, “carrier”, “component carrier”, “bandwidth part (BWP)” and the like may be replaced with each other.

In some embodiments, the terms “terminal”, “terminal device”, “user equipment (UE)”, “user terminal”, “mobile station (MS)”, “mobile terminal (MT)”, “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, etc. may be replaced with each other.

In some embodiments, an access network device, a core network device, or a network device may be replaced by a terminal. For example, the various embodiments of the present disclosure are also applicable to a structure in which communication between the access network equipment, the core network equipment, or the network device and the terminal is replaced by communication between multiple terminals (for example, which may also be called device-to-device (D2D), vehicle-to-everything (V2X), etc.). In this case, the terminal may be configured to have all or part of the functions of the access network device. Furthermore, the terms “uplink” and “downlink” may be replaced with terms corresponding to the communication between the terminals (e.g., “side”). For example, an uplink channel, a downlink channel, etc. may be replaced by a side channel, and an uplink, a downlink, etc. may be replaced by a side link.

In some embodiments, the terminal may be replaced by an access network device, a core network device, or a network device. In this case, the access network device, the core network device, or the network device may be configured to have all or part of the functions of the terminal.

In some embodiments, the names of information and the like are not limited to the names described in the embodiments, and terms such as “information”, “message”, “signal”, “signaling”, “report”, “configuration”, “indication”, “instruction”, “command”, “channel”, “parameter”, “domain”, “field”, “symbol”, “codeword”, “codebook”, “codepoint”, “bit”, “data”, “program”, and “chip” may be replaced with each other.

In some embodiments, terms such as “uplink”, “physical uplink” may be replaced with each other, and terms such as “downlink”, “physical downlink” may be replaced with each other, and terms such as “side”, “sidelink”, “side communication”, “direct connection”, “direct link”, “direct communication”, “direct link communication” may be replaced with each other.

In some embodiments, the terms “downlink control information (DCI)”, “downlink (DL) assignment”, “DL DCI”, “uplink (UL) grant”, “UL DCI” and the like may be replaced with each other.

In some embodiments, terms such as “physical downlink shared channel (PDSCH)” and “DL data” may be replaced with each other, and terms such as “physical uplink shared channel (PUSCH)” and “UL data” may be replaced with each other.

In some embodiments, terms “radio”, “wireless”, “radio access network (RAN)”, “access network (AN)”, “RAN-based” and the like may be replaced with each other.

In some embodiments, terms “search space”, “search space set”, “search space configuration”, “search space set configuration”, “control resource set (CORESET)”, “CORESET configuration” and the like may be replaced with each other.

In some embodiments, terms such as “synchronization signal (SS)”, “synchronization signal block (SSB)”, “reference signal (RS)”, “pilot”, and “pilot signal” may be replaced with each other.

In some embodiments, terms such as “moment”, “time point”, “time”, and “time position” may be replaced with each other, and terms such as “duration”, “period”, “time window”, “window”, and “time” may be replaced with each other.

In some embodiments, terms “component carrier (CC)”, “cell”, “frequency carrier”, “carrier frequency” and the like may be replaced with each other.

In some embodiments, terms such as “resource block (RB)”, “physical resource block (PRB)”, “sub-carrier group (SCG)”, “resource element group (REG)”, “PRB pair”, “RB pair”, and “resource element (RE)” may be replaced with each other.

In some embodiments, terms such as wireless access scheme and waveform may be replaced with each other.

In some embodiments, terms “precoding”, “precoder”, “weight”, “precoding weight”, “quasi-co-location (QCL)”, “transmission configuration indication (TCI) state”, “spatial relation”, “spatial domain filter”, “transmission power”, “phase rotation”, “antenna port”, “antenna port group”, “layer”, “the number of layers”, “rank”, “resource”, “resource set”, “resource group”, “beam”, “beam width”, “beam angular degree”, “antenna”, “antenna element”, “panel” and the like may be replaced with each other.

In some embodiments, terms such as “frame”, “radio frame”, “subframe”, “slot”, “sub-slot”, “mini-slot”, “symbol”, and “transmission time interval (TTI)” may be replaced with each other.

In some embodiments, “obtain”, “get”, “acquire”, “receive”, “transmit”, “bidirectionally transmit”, “send and/or receive” may be replaced with each other, and may be interpreted as receiving from other entities, obtaining from a protocol, obtaining by self-processing, autonomous implementation, etc.

In some embodiments, terms such as “send”, “transmit”, “report”, “download”, “transmit”, “bidirectionally transmit”, “send and/or receive” may be replaced with each other.

In some embodiments, “predetermined” and “preset” may be interpreted as pre-specified in a protocol, etc., or may be interpreted as a pre-set action performed by an apparatus, etc.

In some embodiments, determining may be interpreted as estimating, deciding, judging, calculating, computing, processing, deriving, investigating, searching, looking up, searching, inquiry, ascertaining, receiving, transmitting, inputting, outputting, accessing, resolving, selecting, choosing, establishing, comparing, assuming, expecting, considering, broadcasting, notifying, communicating, forwarding, configuring, reconfiguring, allocating, mapping, assigning, and the like, but is not limited to this.

In some embodiments, the determination or judgment may be performed by a value represented by 1 bit (0 or 1), or by a true or false value (boolean) represented by true or false, or by comparison of numerical values (for example, comparison with a predetermined value), but is not limited to this.

In some embodiments, a “network” may be interpreted as apparatuses included in the network (e.g., access network device, core network device, etc.).

In some embodiments, “not expecting to receive” may be interpreted as not receiving on a time domain resource and/or a frequency domain resource, or as not performing subsequent processing on data after receiving the data; “not expecting to send” may be interpreted as not sending, or as sending but not expecting the recipient to respond to the content sent.

In some embodiments, obtaining data, information, etc. may comply with the laws and regulations of the country where the data is obtained.

In some embodiments, data, information, etc. may be obtained with the user's consent.

In addition, each element, each row, or each column in a table of the embodiments of the present disclosure may be implemented as an independent embodiment, and the combination of any elements, any rows, and any columns may also be implemented as an independent embodiment.

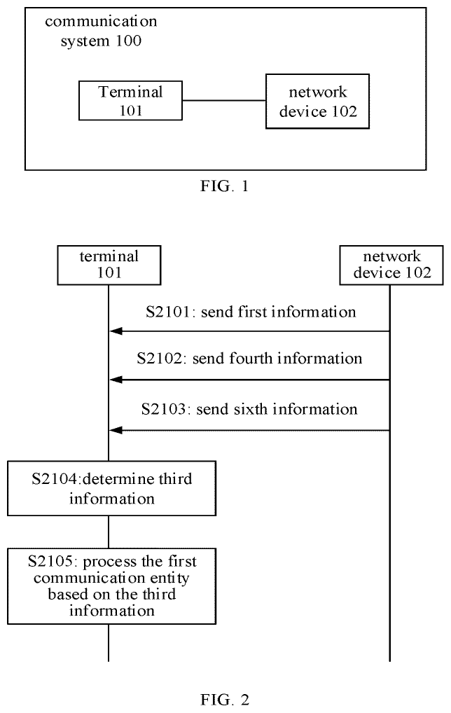

FIG. 1 is a schematic diagram showing an architecture of a communication system according to an embodiment of the present disclosure.

As shown in FIG. 1, a communication system 100 may include a terminal 101 and a network device 102. The network device 102 may include at least one of an access network device or a core network device.

In some embodiments, the terminal 101 includes, but is not limited to, for example, at least one of a mobile phone, a wearable device, an Internet of Things device, a car with communication function, a smart car, a Pad, a computer with wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, or a wireless terminal device in smart home.

In some embodiments, the access network device is, for example, a node or device that accesses a terminal to a wireless network. The access network device may include, but is not limited to, at least one of an evolved NodeB (eNB), a next generation evolved NodeB (ng-eNB), a next generation NodeB (gNB), a node B (NB), a home node B (HNB), a home evolved nodeB (HeNB), a wireless backhaul device, a radio network controller (RNC), a base station controller (BSC), a base transceiver station (BTS), a base band unit (BBU), a mobile switching center, a base station in a 6G communication system, an open base station (Open RAN), a cloud base station (Cloud RAN), a base station in other communication systems, or an access node in a wireless fidelity (WiFi) system.

In some embodiments, the technical solution of the present disclosure is applicable to the Open RAN architecture. In this case, the interfaces between or within the access network devices involved in the embodiments of the present disclosure may be transformed into internal interfaces of the Open RAN, and the processes and information interactions between these internal interfaces may be implemented through software or programs.

In some embodiments, the access network device may be composed of a centralized unit (CU) and a distributed unit (DU), where the CU may also be called a control unit. The CU-DU structure may be used to split a protocol layer of the access network device, with part of the functions of the protocol layer centrally controlled by the CU, and the remaining part or all of the functions of the protocol layer distributed in the DU, which is centrally controlled by the CU. This is not limited in the present disclosure.

In some embodiments, the core network device may be a device including one or more network elements, or may be multiple devices or a group of devices each including all or part of one or more network elements. The network elements may be virtual or physical. The core network, for example, includes at least one of an Evolved Packet Core (EPC), a 5G Core Network (5GCN), or a Next Generation Core (NGC).

In some embodiments, the above-mentioned one or more network elements may include, for example: a Policy Control Function (PCF), an Application Function (AF), a Network Application Function (NAF), an Authentication and Key management for Applications Anchor Function (AAnF), a Bootstrapping Server Functionality (BSF), an Access and Mobility Management Function (AMF), a User Plane Function (UPF), a Session Management Function (SMF), a Mobility Management Entity (MME), etc.

In some embodiments, the above-mentioned PCF, AF, NAF, AAnF, BSF, AMF, UPF, SMF, and MME are used for “function limitation”, and the names are not limited to this.

In some embodiments, the above-mentioned PCF, AF, NAF, AAnF, BSF, AMF, UPF, SMF, and MME may be independent of the core network equipment.

In some embodiments, the above-mentioned PCF, AF, NAF, AAnF, BSF, AMF, UPF, SMF, and MME may be part of the core network device 103.

It can be understood that the communication system described in the embodiment of the present disclosure is for the purpose of more clearly illustrating the technical solution of the embodiments of the present disclosure, and does not constitute a limitation on the technical solution proposed in the embodiments of the present disclosure. The person skilled in the art may know that with the evolution of the system architecture and the emergence of new service scenarios, the technical solution proposed in the embodiments of the present disclosure is also applicable to similar technical problems.

The following embodiments of the present disclosure are applicable to the communication system 100 shown in FIG. 1, or a part of the entities of the communication system. This is not limited in the present disclosure. The entities shown in FIG. 1 are examples. The communication system may include all or part of the entities in FIG. 1, and may also include other entities outside of FIG. 1. The number and form of the entities are arbitrary. The connection relationship between the entities is an example. The entities may be connected or disconnected, and the connection may be in any manner, which may be direct or indirect connection, and may be wired or wireless connection.

The various embodiments of the present disclosure are applicable to a dynamic cell (or cell group) change. For example, in a 5G system, the network may provide multiple candidate cells (or cell groups) to the terminal. The network may subsequently control the terminal to make a change among multiple candidate cells (or cell groups) through an L1 (such as DCI) or L2(MAC CE) signaling (such as changing the working cell (or cell group) from candidate cell (or cell group)-1 to “candidate cell (or cell group)-2). One serving cell (or cell group) may correspond to one or more “candidate cells (or cell groups)”. This procedure may also be called an LTM (L1/L2-triggered Mobility) procedure.

Optionally, in the 5G system, due to the adoption of a Dual Connectivity (DC) architecture, two cell (or cell group) groups are included: Master Cell Group (MCG) corresponding to a network Master Node (MN); and a Secondary Cell Group (SCG) corresponding to a network Secondary Node (SN). The MCG includes a Primary Cell (PCell) (or primary cell group) and one or more Secondary Cells (SCells) (or secondary cell group). The SCG includes a Primary Secondary Cell (PSCell) (or primary secondary cell group) and one or more SCells. The PCell and PSCell may be collectively referred to as Special Cell (SpCell) (or special cell group).

Optionally, the layer 2 entities used by the terminal and the network to control data transmission and reception may include: an MAC, an RLC, a PDCP and a Service Data Adaptation Protocol (SDAP).

When the terminal is moving, the network may reestablish, reset or recover a layer 2 entity through an RRC configuration indication. The reestablishment or resetting is to set a relevant variable of an L2 entity to an initial value (e.g., 1) and discard the stored data. The recovery is retransmitting data of an L2 entity. The reset may be a full resetting or a partial resetting. This is not limited in the present disclosure.

Optionally, in a 5G system, the terminal may be based on network preconfigured conditions and preconfigured cells (or cell groups) corresponding to the conditions. When the terminal meets the “pre-configured conditions” (e.g., a specific measurement event), the terminal changes the serving cell (or cell group) to the “pre-configured cell (or cell group)”. A mobility procedure triggered by the conditions includes: a Conditional Handover (CHO), a Conditional PSCell Addition (CPA) and a Conditional PSCell Change (CPC).

The terminal may also change the configuration of a specific cell (or cell group) according to a network indication after the “pre-configured conditions” are met. For example, the PCell configuration of the terminal is changed from the candidate cell (or cell group) configuration-1 to the candidate cell (or cell group) configuration-2.

FIG. 2 is an interaction schematic diagram illustrating a communication control method according to an embodiment of the present disclosure.

As shown in FIG. 2, an embodiment of the present disclosure relates to a communication control method, which is used in a communication system 100. The method includes the following steps.

Step 2101, a network device 102 sends first information to a terminal 101.

In some embodiments, the terminal 101 may receive the first information sent by the network device 102.

In some embodiments, the first information may indicate an association relationship between second information and third information. The second information may indicate a configuration of at least one candidate cell, and the third information may indicate a manner for processing a first communication entity.

In some embodiments, the first information may indicate the association between the configuration of at least one candidate cell and the manner for processing the first communication entity.

In some embodiments, the present disclosure does not limit the name of the first information, which may be, for example, “association information” or the like. The present disclosure does not limit the form of the first information, which may be, for example, an association relationship table. Optionally, the “association relationship” and a “correspondence relationship” may be replaced with each other. Optionally, the association relationship may be a one-to-one relationship, a one-to-many relationship, or a many-to-many relationship.

In some embodiments, the first information may include a configuration group indicating an association relationship with the third information. Optionally, the configuration group indicating the association relationship with the third information may be indicated by fifth information. Optionally, the first information may be the same as the fifth information. That is, the first information may indicate an association relationship between any two of or an association relationship of three of the configuration of at least one candidate cell, the manner for processing the first communication entity, and the configuration group. For example, the association relationship between the configuration of at least one candidate cell and the configuration group may be a many-to-one relationship (for example, it may be an inclusion relationship, for example, candidate cell #1, candidate cell #2, and candidate cell #3 correspond to configuration group #1,that is, configuration group #1 contains candidate cells #1, #2, and #3, or in other words, candidate cells #1, #2, and #3 belong to configuration group #1), the association relationship between the manner for processing the first communication entity and the configuration group may be a one-to-one relationship, and the association relationship between the configuration of at least one candidate cell and the manner for processing the first communication entity may be a many-to-one relationship. Other possible association relationships are all included in the scope of the present disclosure and will not be repeated here.

In some embodiments, the second information may indicate the configuration of at least one candidate cell. Optionally, the second information may be used to identify the at least one candidate cell.

In some embodiments, the name of the second information is not limited, and it may be, for example, “configuration information of at least one candidate cell” or “identification information of at least one candidate cell”, etc., and is used to identify the at least one candidate cell.

In some embodiments, the second information may include at least one of: a configuration identifier of the at least one candidate cell; or a candidate cell identifier.

In some embodiments, the candidate cell may be a single candidate cell or a cell group including multiple candidate cells. The cell group may be any one of: a cell group including multiple PCells, a cell group including multiple SCells, a cell group including one PCell and one or more SCells, a cell group including one PSCell and one or more SCells, a master cell group (MCG), or a secondary cell group (SCG).

In some embodiments, the second information may be a configuration identifier (e.g., configuration-1) of the candidate cell (or cell group). The “configuration identifier of the candidate cell (or cell group)” may adopt a default configuration identifier stipulated in a protocol agreement for the currently serving cell (or cell group) (for example, adopting the default configuration identifier “0”; or the current serving MCG configuration corresponds to “0”, or the current service SCG configuration corresponds to “1”). The “currently serving cell (or cell group)” may be a cell (or cell group) serves when the terminal first receives the first information (that is, the association relationship between the configuration of at least one candidate cell and the manner for processing the first communication entity, or the association relationship between any two or three of the configuration of at least one candidate cell, the manner for processing the first communication entity, and the configuration group), or the cell (or cell group) serves when the terminal first receives the fifth information (that is, the configuration group information), or the cell (or cell group) serves when the terminal first receives the configuration of the candidate cell (or cell group), or the cell (or cell group) serves when the terminal first receives the configuration of a source cell and/or a target cell. In some embodiments, the “current serving cell (or cell group)” may be a cell (or cell group) serves when the terminal first receives a “Layer 2 processing manner configuration of the configuration group”, or a cell (or cell group) serves when the terminal first receives the “candidate cell (or cell group) configuration”.

In some embodiments, the second information may be an identifier of a candidate cell (or cell group) (e.g., cell-1, or cellGroup-1). The candidate cell group identifier may include an MCG or an SCG. The candidate cell identifier may include at least one of: a physical cell identifier (such as PCI-1 (Physical Cell Identifier)), a cell global identifier (such as CGI-1 (Cell Global Identifier)), or a frequency point identifier (such as ARFCN (Absolute Radio Frequency Channel Number)).

In some embodiments, the third information may indicate the manner for processing the first communication entity.

In some embodiments, the name of the third information is not limited, and it may be, for example, “manner for processing a communication entity”, “manner for controlling a communication entity”, etc. It should be understood that the “manner for processing” described in the embodiments of the present disclosure may be replaced with the “manner for controlling”, which may include a manner for processing (or controlling) the first communication entity. For example, the manner for processing (or controlling) the first communication entity may include at least one of: reestablishment, reset, or recovery. The “reset” may also be called “resetting”, and the two are interchangeable, which is not limited in the present disclosure. The reestablishment or resetting is to set relevant variables of a communication entity (e.g., a layer 2 entity) to initial values (e.g., 1) and discard stored data; and the recovery is retransmitting data of a communication entity. The resetting may be a full resetting or a partial resetting, and which is not limited in the present disclosure.

In some embodiments, the first communication entity may be a layer 2 entity (L 2 entity), or may be other communication entities, which is not limited in the present disclosure. For example, the name of the third information may also be, for example, “manner for processing a layer 2 entity”, “manner for controlling a layer 2 entity”, etc. In some embodiments, the layer 2 entity may include at least one of: an MAC, an RLC, a PDCP or an SDAP.

In some embodiments, the third information may include at least one of: indication information on whether to reset or partially reset an MAC entity; indication information on whether to reestablish an RLC entity; indication information on whether to reestablish a PDCP entity; or indication information on whether to recover a PDCP entity.

In some embodiments, the third information may be configured by the network. For example, the terminal may receive a message or a signaling sent by the network device, which carries and indicates the manner for processing the communication entity configured by the network device for the terminal, such as the network device indicates that the terminal resets or partially resets the MAC entity. In some embodiments, the third information may be stipulated in a protocol agreement. For example, the protocol may stipulate resetting or partially resetting the MAC entity in a specific scenario, where the specific scenario may be that the network device instructs the terminal to perform cell handover through a signaling, or perform cell handover when specific trigger conditions are met”, where the specific trigger conditions may be configured by the network device, or may be agreed upon or predefined by a protocol, which is not limited in the present disclosure.

In some embodiments, the network device may send the first information to the terminal by sending a message or a signaling. For example, the network device 102 sends a first signaling, which may include the indication information of the association relationship between the second information and the third information. Correspondingly, the terminal 101 may receive the first signaling. The first signaling may be but is not limited to, for example, a physical downlink control information (DCI) signaling, and may also be other signaling (such as a medium access control element (L2) signaling, etc.).

For example, in some embodiments, the network device sends the first information to the terminal, which may be used to indicate: indication information corresponding to resetting or partially resetting of the MAC entity when the candidate cell configuration identifier is configured as “1”.

Step 2102, the network device 102 sends fourth information to the terminal 101.

In some embodiments, the terminal 101 may receive the fourth information sent by the network device 102.

In some embodiments, the fourth information indicates a configuration of a first cell and/or a second cell corresponding to the terminal.

In some embodiments, the fourth information indicates identification information of the first cell and/or the second cell corresponding to the terminal.

The first cell may be a source cell corresponding to the terminal (it may also be understood as a service cell currently serving the terminal, that is, the service cell before the cell handover); the second cell may be a target cell corresponding to the terminal (it may also be understood as a cell serving the terminal after the handover, that is, the service cell after the cell handover).

In some embodiments, the second information may include the fourth information. Optionally, the fourth information may be the second information. For example, the first cell and the second cell may be cells in the at least one candidate cell. That is, the at least one candidate cell may include at least one of the first cell or the second cell.

In some embodiments, the fourth information may include at least one of: a configuration identifier of the first cell and/or the second cell; or a cell identifier of the first cell and/or the second cell. For the configuration identifier of the first cell and/or the second cell, reference can be made to the above-mentioned description of the configuration identifier of at least one candidate cell (or cell group), and for the cell identifier of the first cell and/or the second cell, reference can be made to the above-mentioned description of the candidate cell (or cell group) identifier, which will not be repeated here.

In some embodiments, the network device may send the fourth information to the terminal by sending a message or a signaling. For example, the network device may send a second signaling, where the second signaling may include a configuration identifier of the first cell and/or the second cell corresponding to one or more terminals. The second signaling may be but is not limited to, for example, a physical downlink control information (DCI) signaling, and may also be another signaling (such as a medium access control element (L2) signaling, etc.). In some embodiments, the first information and the fourth information may be sent through the same message or signaling, or through different messages or signaling, and may be sent simultaneously or separately, which is not limited in the present disclosure.

For example, the configuration identifier of the first cell or the second cell sent by the network device to the terminal may be “1” or “0”. In some embodiments, before the cell handover, the source cell serves as the current serving cell (or cell group), and its configuration identifier may be the default configuration identifier stipulated in a protocol agreement, for example, the default configuration identifier “0” is used, or a current serving MCG configuration corresponds to “0”, or a current serving SCG configuration corresponds to “1”.

Step 2103, the network device 102 sends sixth information to the terminal 101.

In some embodiments, the terminal 101 may receive the sixth information sent by the network device.

In some embodiments, the sixth information indicates a mobility usage of the terminal. The mobility usage of the terminal may be a usage of a cell handover, for example, a mobility usage based on conditional triggering, such as a mobility usage triggered by a physical layer signaling, and the like.

In some embodiments, the mobility usage of the terminal may include at least one of: the network device may control the terminal to change multiple “candidate cells (or cell groups)” (such as a “dynamic cell (or cell group) change”) through a signaling; or the terminal changes the configuration to the candidate cell (or cell group) configuration when a trigger condition of a network configuration or protocol agreement is met (such as when a terminal measurement meets an A3 or A5 event, a serving MCG configuration is changed to a candidate MCG configuration). The mobility of the terminal may also be used for other usage besides the above usages, which will not be described in detail here.

In some embodiments, the network device may send the sixth information to the terminal by sending a message or a signaling. For example, the network device may send a third signaling, where the third signaling may include one or more identifiers of terminal mobility usages. The third signaling may be but is not limited to, for example, a physical downlink control information (DCI) signaling, and may also be another signaling (such as a medium access control unit (L2) signaling, etc.). In some embodiments, the first information, the fourth information, and the sixth information may be sent through the same message or signaling, or through different messages or signaling, or may be sent simultaneously or separately, which is not limited in the present disclosure.

The above steps 2101-2103 may be alternative steps, that is, one step or multiple steps may be performed, which is not limited by the present disclosure.

In some embodiments, step 2103 may be an alternative step. In other words, the terminal does not need to determine the mobility usage, and for any mobility process, performs the step of “determining whether fifth information corresponding to the fourth information exists based on the first information”. This is not limited in the present disclosure.

Step 2104, the terminal determines third information.

In some embodiments, the terminal may determine whether fifth information corresponding to the fourth information exists based on the first information, where the fifth information indicates the configuration group having the association relationship with the third information; and if the fifth information exists, the terminal may determine the third information based on the fifth information.

In some embodiments, the fifth information indicates the configuration group having the association relationship with the third information. Regarding the configuration group, the relationship between the fifth information and the first information, the relationship between the fifth information and the second information, and the configuration or sending method of the fifth information, reference can be made to the above descriptions and will not be repeated here.

In some embodiments, the terminal may determine the third information through the following steps (1) and (2).

Step (1), the terminal determines, based on the first information, whether the fifth information corresponding to the fourth information exists.

In some embodiments, step (1) may be performed when the sixth information meets the first condition. In some embodiments, when step 2103 is not performed, the sixth information may not be restricted to meeting the first condition.

In some embodiments, the first condition includes at least one of the following 1) or 2).

1) The terminal performing cell handover based on a signaling of the network device.

For example, the network device may control the terminal to make a change among multiple “candidate cells (or cell groups)” (e.g., a “dynamic cell (or cell group) change”) via a signaling.

For example, the “dynamic cell (or cell group) change” may also be called an L1/L2-triggered Mobility (LTM) procedure, which means that in the 5G system, the network may provide multiple “candidate cells (or cell groups)” to the terminal. The network may subsequently control the terminal to change among multiple “candidate cells (or cell groups)” via an L1 (e.g., a DCI) or an L2 (a MAC CE) signaling. For example, the working cell (or cell group) is changed from “candidate cell (or cell group) #1” to “candidate cell (or cell group) #2”, that is, the service provided by “candidate cell (or cell group) #1” to the terminal is changed to the service provided by “candidate cell (or cell group) #2”.

2) The terminal performing cell handover in response to meeting a triggering condition configured by the network device or a triggering condition stipulated in a protocol agreement.

For example, when the trigger condition configured by the network or stipulated in the protocol agreement is met, the terminal changes the configuration to a candidate cell (or cell group) configuration.

For example, when a terminal measurement meets an A3 or A5 event, a serving MCG configuration is changed to a candidate MCG configuration. For example, MCG #1 is changed from a serving MCG to a candidate MCG, that is, MCG #1 no longer provides services for the terminal.

In some embodiments, when the mobility usage indicated by the network device to the terminal meets two usages in the above-mentioned first condition, the terminal determines whether there is a configuration group corresponding to a source cell and/or a target cell corresponding to the terminal, based on the association relationship between the configuration of at least one candidate cell and the manner for processing the first communication entity.

For example, the mobility usage indicated by the network device is the network device may control the terminal to change among the multiple “candidate cells (or cell groups) via a signaling, which meets 1) of the above-mentioned first condition, configuration group #1 includes the configuration identifier Configuration #1 of the candidate cell and the configuration identifier Configuration #2 of the candidate cell, and the configuration identifier of the target cell is Configuration #2, then the terminal determines that the configuration of the target cell belongs to configuration group #1, and the terminal determines that there is a configuration group corresponding to the target cell.

For another example, the mobility usage indicated by the network device is the configuration is changed to the candidate cell when the triggering condition configured by the network device or the triggering condition stipulated in the protocol agreement is met, which meets 2) of the first condition above. The configuration group #2 includes the identifier of the candidate cell Cell #1 and the identifier of the candidate cell Cell #2. The identifier of the source cell is Cell #1 and the identifier of the target cell is Cell #2. The terminal determines that the source cell and the target cell belong to the same configuration group #2, and the terminal determines that there is a corresponding configuration group.

Step (2), the terminal determines the third information based on the fifth information.

In some embodiments, step (2) may be performed in the presence of the fifth information.

In some embodiments, the terminal may determine that the fifth information corresponding to the fourth information exists when the configuration of at least one of the first cell or the second cell belongs to the fifth information.

In some embodiments, the terminal may determine that there is the fifth information corresponding to the fourth information when the configuration of at least one of the first cell or the second cell belongs to the fifth information. Situations that the configuration of at least one of the first cell or the second cell belongs to the fifth information may be as follows. In other words, the terminal may determine that there is the configuration group corresponding to the source cell and/or the target cell when any of the following situations are met, that is, determine that there is the fifth information corresponding to the fourth information, and may determine the manner for processing the communication entity based on the configuration group.

a) The configuration of the source cell belongs to a specific configuration group.

For example, the configuration identifier of the source cell is Configuration #1, and configuration group #1 includes the candidate cell configuration identifier Configuration #1. For another example, the identifier of the source cell is Cell #1, and configuration group #1 includes the candidate cell identifier Cell #1, then the configuration of the source cell belongs to configuration group #1.

b) The configuration of the target cell belongs to a specific configuration group.

For example, the configuration identifier of the target cell is Configuration #1, and configuration group #1 includes the candidate cell configuration identifier Configuration #1. For another example, the identifier of the target cell is Cell #1, and configuration group #1 includes the candidate cell identifier Cell #1, then the configuration of the target cell belongs to configuration group #1.

c) The source cell and the target cell belong to different configuration groups.

For example, the source cell identifier is Cell #1, configuration group #1 includes the candidate cell identifier Cell #1, and the configuration of the source cell belongs to configuration group #1. The identifier of the target cell is Cell #2, and configuration group #2 includes the candidate cell identifier Cell #2, so the configuration of the target cell belongs to configuration group #2.

d) The source cell and the target cell belong to the same configuration group.

For example, the source cell identifier is Cell #1, configuration group #1 includes the candidate cell identifier Cell #1, and the configuration of the source cell belongs to configuration group #1. The identifier of the target cell is Cell #2, and configuration group #1 also includes the candidate cell identifier Cell #2, so the configuration of the target cell belongs to configuration group #1.

In some embodiments, “determining the fifth information corresponding to the fourth information exists in response to the configuration of at least one of the first cell or the second cell belonging to the fifth information” includes: determining seventh information, in which the seventh information is fifth information corresponding to the first cell, that is, the seventh information is a configuration group corresponding to the source cell; determining the eighth information, in which the eighth information is fifth information corresponding to the second cell, that is, the eighth information is a configuration group corresponding to the target cell.

In some embodiments, any of the seventh information or the eighth information may exist, or both the seventh information and the eighth information may exist. In other words, the source cell may belong to a specific configuration group, the target cell may belong to a specific configuration group, or both the source cell and the target cell may belong to the specific configuration group.

In some embodiments, the seventh information and the eighth information may be the same or different. In other words, the source cell and the target cell may belong to the same configuration group, or the source cell and the target cell may belong to different configuration groups. For example, in some embodiments, the configuration identifier of the target cell is Configuration #1, configuration group #1 includes the configuration identifier Configuration #1 of the candidate cell, and the manner for processing the communication entity corresponding to configuration group #1 is resetting or partially resetting the MAC entity, then the terminal may determine to reset or partially reset the MAC entity.

In some embodiments, the terminal may determine the third information through the above step (1) and the following step (3).

Step (3), the terminal determines the third information based on the protocol agreement.

In some embodiments, step (3) may be performed in the absence of the fifth information. In other words, step (3) and step (2) are alternative steps, and the manner of determining the third information depends on whether the fifth information exists in step (1).

In some embodiments, when the configuration identifiers of the first cell and the second cell are not in the configuration group, the terminal may determine the manner for controlling the communication entity based on the predefined protocol agreement.

In some embodiments, corresponding to a), b), c), and d) listed in the above step (2), “the configuration of the first cell and the second cell does not belong to the fifth information” may include the following situations. In other words, when the terminal meets the following conditions, it may determine that there is no corresponding configuration group for the source cell and/or the target cell, that is, there is no fifth information corresponding to the fourth information, then the terminal may determine the manner for controlling the communication entity based on the protocol agreement.

e) The configurations of the source cell and the target cell do not belong to a specific configuration group.

For example, the configuration identifier of the source cell is Configuration #1, and no configuration group includes the candidate cell configuration identifier Configuration #1. For another example, the identifier of the source cell is Cell #1, and no configuration group includes the candidate cell identifier Cell #1. In these case, the configuration of the source cell does not belong to a specific configuration group.

For example, the configuration identifier of the target cell is Configuration #1, and no configuration group includes the candidate cell configuration identifier Configuration #1. For another example, the identifier of the target cell is Cell #1, and no configuration group includes the candidate cell identifier Cell #1. In these case, the configuration of the target cell does not belong to a specific configuration group.

f) The identifiers or configuration identifiers of the source cell and the target cell are not in the configuration of the candidate cell.

For example, the configuration identifier of the source cell is Configuration #1, which does not belong to the configuration of at least one candidate cell configured by the network device to the terminal. For another example, the identifier of the source cell is Cell #1, which does not belong to the at least one candidate cell configured by the network device to the terminal.

For another example, the configuration identifier of the target cell is Configuration #1, which does not belong to the configuration of at least one candidate cell configured by the network device to the terminal. For another example, the identifier of the source cell is Cell #1, which does not belong to the at least one candidate cell configured by the network device to the terminal.

For example, the configuration identifier Configuration #1 of the source cell and the configuration identifier Configuration #2 of the target cell are not in any configuration group, that is, it meets the above situation e), the protocol agreement may stipulate that when the configurations of the source cell and the target cell do not belong to a specific configuration group, the corresponding manner for controlling the communication entity is reestablishing the MAC entity. The terminal may determine the manner for controlling the communication entity as reestablishing the MAC entity based on the protocol agreement.

Step 2105, the terminal processes the first communication entity based on the third information.

In some embodiments, the terminal may process the first communication entity based on the third information determined in step (2) above. For example, when at least the configuration of the second cell belongs to the fifth information, the terminal may process the first communication entity based on the third information corresponding to the fifth information.

In other words, the terminal may process the first communication entity according to the manner for processing the first communication entity determined in step (2). The processing of the first communication entity may include: performing at least one of a reestablishment process, a reset or partial reset process (or in other words, a resetting process), or a recovery process on the first communication entity.

For example, in some embodiments, if the manner for processing the first communication entity determined by the terminal is resetting the MAC entity, the terminal may reset the MAC entity.

In some embodiments, the terminal may process the first communication entity based on the third information determined in step (3) above. For example, when neither the first cell nor the second cell belongs to the fifth information, the terminal may process the first communication entity in a communication processing manner stipulated in the protocol agreement.

In other words, the terminal may process the first communication entity according to the manner for processing the first communication entity determined in step (3). The processing of the first communication entity may include: performing at least one of a reestablishment process, a reset or partial reset process (or in other words, a resetting process), or a recovery process on the first communication entity.

For example, in some embodiments, if the terminal determines according to the protocol agreement that the manner for processing the first communication entity is resetting the MAC entity, the terminal may reset the MAC entity.

The communication methods involved in the embodiments of the present disclosure may include at least one of steps 2101 to 2105. For example, step 2101 may be implemented as an independent embodiment, step 2103 may be implemented as an independent embodiment, steps 2101+2102+2104+2105 may be implemented as an independent embodiment, and step 2101+2102+2103 may be implemented as an independent embodiment, which is not limited in the present disclosure.

In some embodiments, steps 2101, 2102, and 2103 may be performed in an interchanged order or simultaneously.

In some embodiments, step 2102, step 2103, step 2104, and step 2105 may be performed, and one or more of these steps may be omitted or replaced in different embodiments.

In some embodiments, step 2101, step 2102, step 2104, and step 2105 may be performed, and one or more of these steps may be omitted or replaced in different embodiments.

In the embodiments or implementations, unless there is any contradiction, each step may be independent, arbitrarily combined or exchanged in order, the embodiments or implementations may be arbitrarily combined, and may be arbitrarily combined with any steps of other embodiments or other implementations.

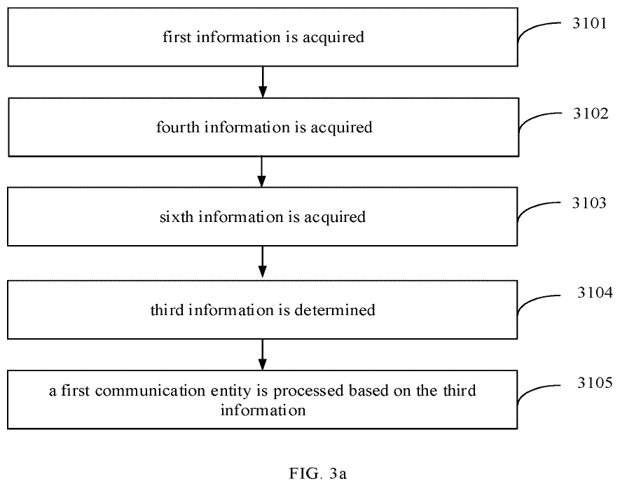

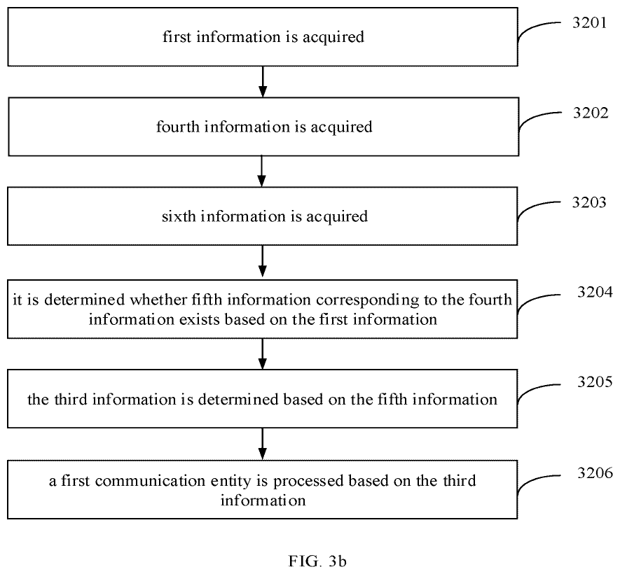

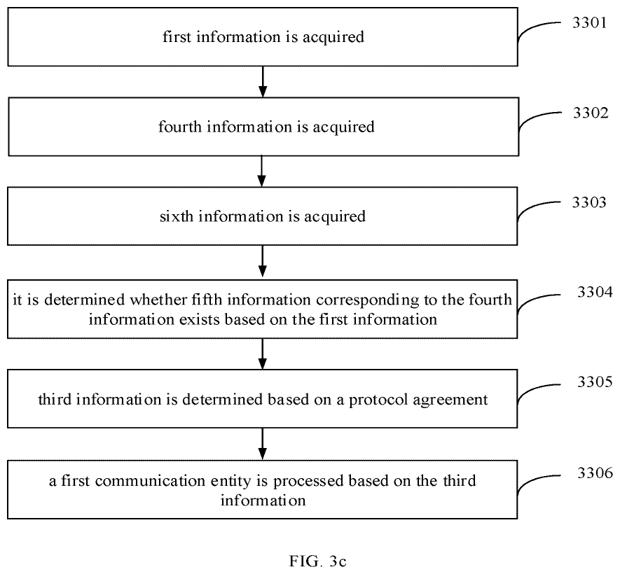

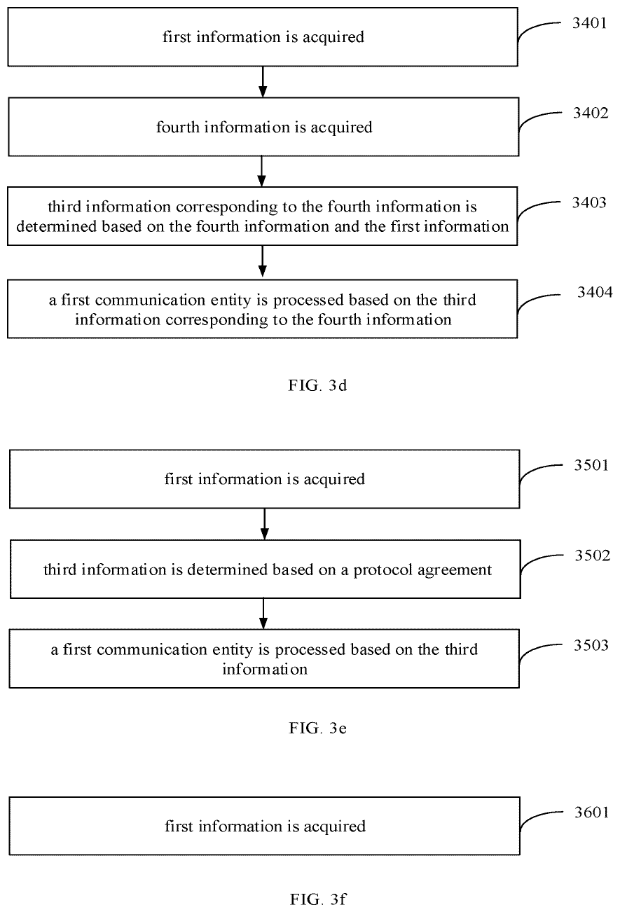

FIG. 3a is a schematic flow chart of a communication control method according to an embodiment of the present disclosure. As shown in FIG. 3a, an embodiment of the present disclosure relates to a communication control method, which is applicable to a terminal 101. The method includes the following steps.

Step 3101, first information is acquired.

For implementations of step S3101, reference can be made to the implementations of step S2101 in FIG. 2 and other related parts in the embodiments involved in FIG. 2, which will not be repeated here.

In some embodiments, the terminal 101 may receive the first information sent by the network device 102. This is not limited in the present disclosure. The terminal 101 may also receive the first information sent by another entity.

In some embodiments, the terminal 101 may acquire the first information specified by the protocol.

In some embodiments, the terminal 101 receives the first information via an upper layer(s).

In some embodiments, the terminal 101 performs processing to obtain the first information.

In some embodiments, step S3101 is omitted, and the terminal 101 autonomously implements the function indicated by the first information, or the above function is default or by default.

Step 3102, fourth information is acquired.

For implementations of step S3102, reference can be made to the implementations of step S2102 in FIG. 2 and other related parts in the embodiments involved in FIG. 2, which will not be repeated here.

In some embodiments, the terminal 101 may receive the fourth information sent by the network device 102. This is not limited in the present disclosure. The terminal 101 may also receive the fourth information sent by another entity.

In some embodiments, the terminal 101 may acquire the fourth information specified by the protocol.

In some embodiments, the terminal 101 receives the fourth information via an upper layer(s).

In some embodiments, the terminal 101 performs processing to acquire the fourth information.

In some embodiments, step S3102 is omitted, and the terminal 101 autonomously implements the function indicated by the first information, or the above function is default or by default.

Step 3103, sixth information is acquired.

For implementations of step S3103, reference can be made to the implementations of step S2103 in FIG. 2 and other related parts in the embodiments involved in FIG. 2, which will not be repeated here.

In some embodiments, the terminal 101 may receive the first information sent by the network device 102. This is not limited in the present disclosure. The terminal 101 may also receive the sixth information sent by another entity.

In some embodiments, the terminal 101 may obtain the sixth information specified by the protocol.

In some embodiments, the terminal 101 receives the sixth information via an upper layer(s).

In some embodiments, the terminal 101 performs processing to acquire the sixth information.

In some embodiments, step S3103 is omitted, and the terminal 101 autonomously implements the function indicated by the first information, or the above function is default or by default.

Step 3104, third information is determined.

For implementations of step S3104, reference can be made to the implementations of step S2104 in FIG. 2 and other related parts in the embodiments involved in FIG. 2, which will not be repeated here.

Step 3105, a first communication entity is processed based on the third information.

For implementations of step S3105, reference can be made to the implementations of step S2105 in FIG. 2 and other related parts in the embodiments involved in FIG. 2, which will not be repeated here.

The communication methods involved in the embodiments of the present disclosure may include at least one of steps 3101 to 3105. For example, step 3101 may be implemented as an independent embodiment, step 3103 may be implemented as an independent embodiment, steps 3101+3102+3104+3105 may be implemented as an independent embodiment, and step 3101+3102+3103 may be implemented as an independent embodiment. This is not limited in the present disclosure.

In some embodiments, steps 3101, 3102, and 3103 may be performed in an interchanged order or simultaneously.

In some embodiments, step 3102, step 3103, step 3104, and step 3105 may be performed, and one or more of these steps may be omitted or replaced in different embodiments.

In some embodiments, step 3101, step 3102, step 3104, and step 3105 may be performed, and one or more of these steps may be omitted or replaced in different embodiments.

In the embodiments or the implementations, unless there is any contradiction, each step may be independent, arbitrarily combined or exchanged in order, the embodiments or implementations may be arbitrarily combined, and may be arbitrarily combined with any steps of other embodiments or other implementations.

FIG. 3b is a flow chart of a communication control method according to an embodiment of the present disclosure. As shown in FIG. 3b, an embodiment of the present disclosure relates to a communication control method, which is applicable to a terminal 101. The method includes the following steps.

Step 3201, first information is acquired.

In some embodiments, the terminal 101 receives the first information sent by a network device.

In some embodiments, the first information indicates an association relationship between second information and third information, the second information indicates a configuration of at least one candidate cell, and the third information indicates a manner for processing a first communication entity.

For implementations of step 3201, reference can be made to the implementations of step 2101 of FIG. 2, the implementations of step 3101 of FIG. 3a, and other related parts of the embodiments involved in FIG. 2, which will not be described in detail here.

Step 3202, fourth information is acquired.

In some embodiments, the terminal 101 receives the fourth information sent by the network device.

In some embodiments, the fourth information indicates the configuration of the first cell and/or the second cell corresponding to the terminal.

For implementations of step 3202, reference can be made to the implementations of in step 2102 of FIG. 2, the implementations of step 3102 of FIG. 3a, and other related parts of the embodiments involved in FIG. 2, which will not be described in detail here.

Step 3203, sixth information is acquired.

In some embodiments, the terminal 101 receives the sixth information sent by the network device.

In some embodiments, the sixth information indicates a mobility usage of the terminal.

For implementations of step 3203, reference can be made to the implementations of step 2103 of FIG. 2, the implementations of step 3103 of FIG. 3a, and other related parts of the embodiments involved in FIG. 2, which will not be described in detail here.

Step 3204, it is determined whether fifth information corresponding to the fourth information exists based on the first information.

In some embodiments, the terminal 101 determines whether the fifth information corresponding to the fourth information exists based on the first information.

In some embodiments, the above step 3204 may be performed when the sixth information meets the first condition.

In some embodiments, the first condition includes at least one of: the terminal performing cell handover based on a signaling of the network device; or the terminal performing cell handover in response to meeting a triggering condition configured by the network device or a triggering condition stipulated in a protocol agreement.

In some embodiments, the fifth information indicates a configuration group having an association relationship with the third information.

For implementations of step 3204, reference can be made to the implementations of step 2104 of FIG. 2, the implementations of step 3104 of FIG. 3a, and other related parts in the embodiments involved in FIG. 2, which will not be repeated here.

Step 3205, the third information is determined based on the fifth information.

In some embodiments, the above step 3205 may be performed in the presence of the fifth information.

Optionally, in some embodiments, the terminal may determine that there is the fifth information corresponding to the fourth information when the configuration of at least one of the first cell or the second cell belongs to the fifth information.

In some embodiments, when the configuration of at least one of the first cell or the second cell belongs to the fifth information, it is determined that there is the fifth information corresponding to the fourth information.

In some embodiments, determining the fifth information corresponding to the fourth information exists includes at least one of: determining seventh information, where the seventh information is first fifth information corresponding to the first cell; determining eighth information, where the eighth information is second fifth information corresponding to the second cell.

In some embodiments, the seventh information and the eighth information may be the same or different.

For implementations of step 3205, reference can be made to the implementations of step 2105 of FIG. 2, the implementations of step 3104 of FIG. 3a, and other related parts of the embodiments involved in FIG. 2, which will not be described in detail here.

Step 3206, a first communication entity is processed based on the third information.

In some embodiments, processing the first communication entity based on the third information corresponding to the fourth information includes: when at least the configuration of the second cell belongs to the fifth information, processing the first communication entity based on the third information corresponding to the fifth information.

For implementations of step 3206, reference can be made to the implementations of step 2106 in FIG. 2, the implementations of step 3105 in FIG. 3a, and other related parts in the embodiments involved in FIG. 2, which will not be described in detail here.

For detailed descriptions of steps 3201-3206, reference can made to the embodiments shown in FIG. 2.

The communication control methods involved in the embodiments of the present disclosure may include at least one of steps 3201 to 3206. For example, step 3201 may be implemented as an independent embodiment, and step 3202 may be implemented as an independent embodiment, which is not limited in the present disclosure.

In the embodiments or the implementations, unless there is any contradiction, each step may be independent, arbitrarily combined or exchanged in order, and the embodiments or implementations may be arbitrarily combined and may be arbitrarily combined with other embodiments or implementations.

FIG. 3c is a flow chart of a communication control method according to an embodiment of the present disclosure. As shown in FIG. 3c, an embodiment of the present disclosure relates to a communication control method, which is applicable to a terminal 101. The method includes the following steps.

Step 3301, first information is acquired.

In some embodiments, the terminal 101 may receive the first information sent by a network device.

In some embodiments, the first information indicates an association relationship between second information and third information, the second information indicates a configuration of at least one candidate cell, and the third information indicates a manner for processing a first communication entity.

For implementations of step 3301, reference can be made to the implementations of step 2101 of FIG. 2, the implementations of step 3101 of FIG. 3a, the implementations of step 3201 of FIG. 3b, and other related parts of the embodiments involved in FIG. 2, which will not be repeated here.

Step 3302, fourth information is acquired.

In some embodiments, the terminal 101 may receive the fourth information sent by the network device.

In some embodiments, the fourth information indicates a configuration of a first cell and/or a second cell corresponding to the terminal.

For implementations of step 3302, reference can be made to the implementations of step 2102 of FIG. 2, the implementations of step 3102 of FIG. 3a, the implementations of step 3202 of FIG. 3b, and other related parts of the embodiments involved in FIG. 2, which will not be described in detail here.

Step 3303, sixth information is acquired.

In some embodiments, the terminal 101 may receive the sixth information sent by the network device.

In some embodiments, the sixth information indicates a mobility usage of the terminal.

For implementations of step 3303, reference can be made to the implementations of step 2103 in FIG. 2, the implementations of step 3103 in FIG. 3a, the implementations of step 3203 in FIG. 3b, and other related parts in the embodiments involved in FIG. 2, which will not be described in detail here.

Step 3304, it is determined whether fifth information corresponding to the fourth information exists based on the first information.

In some embodiments, the above step 3304 may be performed when the sixth information meets the first condition.

In some embodiments, the first condition includes at least one of: the terminal performing cell handover based on a signaling of the network device; or the terminal performing cell handover in response to meeting a triggering condition configured by the network device or a triggering condition stipulated in a protocol agreement.

In some embodiments, the fifth information indicates a configuration group having an association relationship with the third information.

For implementations of step 3304, reference can be made to the implementations of step 2104 in FIG. 2, the implementations of step 3104 in FIG. 3a, the implementations of step 3204 in FIG. 3b, and other related parts in the embodiments involved in FIG. 2, which will not be described in detail here.

Step 3305, third information is determined based on a protocol agreement.

In some embodiments, the above step 3305 may be performed in the absence of the fifth information.

In some implementations, the terminal may determine that there is the fifth information corresponding to the fourth information when the configuration of at least one of the first cell or the second cell belongs to the fifth information.

In some embodiments, when the configuration of at least one of the first cell or the second cell belongs to the fifth information, it is determined that there is the fifth information corresponding to the fourth information.

In some embodiments, determining the fifth information corresponding to the fourth information exists includes at least one of: determining seventh information, where the seventh information is first fifth information corresponding to the first cell; determining eighth information, where the eighth information is second fifth information corresponding to the second cell.

In some embodiments, the seventh information and the eighth information may be the same or different.

For implementations of step 3305, reference can be made to the implementations of step 2104 of FIG. 2, the implementations of step 3104 of FIG. 3a, and other related parts of the embodiments involved in FIG. 2, which will not be described in detail here.

Step 3306, a first communication entity is processed based on the third information.

In some embodiments, processing the first communication entity based on third information corresponding to the fourth information includes: when the configuration of at least the second cell belongs to the fifth information, processing the first communication entity based on the third information corresponding to the fifth information.

For implementations of step 3306, reference can be made to the implementations of step 2105 of FIG. 2, the implementations of step 3105 of FIG. 3a, and other related parts of the embodiments involved in FIG. 2, which will not be described in detail here.

For detailed descriptions of steps 3301-3306, reference can be made to the embodiments shown in FIG. 2, FIG. 3a, and FIG. 3b.

The communication control method involved in the embodiments of the present disclosure may include at least one of steps 3301 to 3306. For example, step 3301 may be implemented as an independent embodiment, and step 3302 may be implemented as an independent embodiment, which is not limited in the present disclosure.

In the embodiments or the implementations, unless there is any contradiction, each step may be independent, arbitrarily combined or exchanged in order, and the embodiments or the implementations may be arbitrarily combined and may be arbitrarily combined with other embodiments or implementations.

FIG. 3d is a flow chart of a communication control method according to an embodiment of the present disclosure. As shown in FIG. 3d, an embodiment of the present disclosure relates to a communication control method, which is applicable to a terminal 101. The method includes:

Step 3401, first information is acquired.

In some embodiments, the terminal 101 may receive first information sent by a network device.

In some embodiments, the first information indicates an association relationship between second information and third information, the second information indicates a configuration of at least one candidate cell, and the third information indicates a manner for processing a first communication entity.

For implementations of step 3401, reference can be made to the implementations of step 2101 in FIG. 2, the implementations of step 3101 in FIG. 3a, the implementations of step 3201 in FIG. 3b, the implementations of step 3301 in FIG. 3c, and other related parts in the embodiments involved in FIG. 2, which will not be repeated here.

Step 3402, fourth information is acquired.

In some embodiments, the terminal 101 may receive the fourth information sent by the network device.

In some embodiments, the fourth information indicates a configuration of a first cell and/or a second cell corresponding to the terminal.

For implementations of step 3402, reference can be made to the implementations of step 2102 of FIG. 2, the implementations of step 3102 of FIG. 3a, step 3202 of FIG. 3b, and the implementations of step 3302 of FIG. 3c, as well as other related parts in the embodiments involved in FIG. 2, which will not be repeated here.

Step 3403, third information corresponding to the fourth information is determined based on the fourth information and the first information.

In some embodiments, the above-mentioned step 3403 may include: determining, based on the first information, whether there is fifth information corresponding to the fourth information, where the fifth information indicates a configuration group having an association relationship with the third information; and if the fifth information exists, determining the third information based on the fifth information.

In some embodiments, the first condition includes at least one of: the terminal performing cell handover based on a signaling of the network device; or the terminal performing cell handover in response to meeting a triggering condition configured by the network device or a triggering condition stipulated in a protocol agreement.

In some implementations, the terminal may determine that there is the fifth information corresponding to the fourth information when the configuration of at least one of the first cell or the second cell belongs to the fifth information.

In some embodiments, when the configuration of at least one of the first cell or the second cell belongs to the fifth information, it is determined that there is the fifth information corresponding to the fourth information.

In some embodiments, determining the fifth information corresponding to the fourth information exists includes at least one of: determining seventh information, where the seventh information is first fifth information corresponding to the first cell; determining eighth information, where the eighth information is second fifth information corresponding to the second cell.

In some embodiments, the seventh information and the eighth information may be the same or different.

For implementations of step 3403, reference can made to the implementations of the step 2104 of FIG. 2, the implementations of step 3104 of FIG. 3a, the implementations of steps 3204+3205 of FIG. 3b, and the implementations of steps 3304+3305 of FIG. 3c, as well as other related parts in the embodiments involved in FIG. 2, which will not be repeated here.

Step 3404, a first communication entity is processed based on the third information corresponding to the fourth information.

In some embodiments, processing the first communication entity based on the third information corresponding to the fourth information includes: when the configuration of at least the second cell belongs to the fifth information, processing the first communication entity based on the third information corresponding to the fifth information.

For implementations of step 3404, reference can be made to the implementations of step 2105 of FIG. 2, the implementations of step 3105 of FIG. 3a, step 3206 of FIG. 3b, and the implementations of step 3306 of FIG. 3c, as well as other related parts in the embodiments involved in FIG. 2, which will not be repeated here.

For detailed descriptions of steps 3401-3404, reference can be made to the above-mentioned embodiments of FIGS. 2, 3a, and 3b.

The communication control method involved in the embodiments of the present disclosure may include at least one of steps 3401 to 3404. For example, step 3401 may be implemented as an independent embodiment, and step 3402 may be implemented as an independent embodiment, which is not limited in the present disclosure.

In the embodiments or the implementations, unless there is any contradiction, each step may be independent, arbitrarily combined or exchanged in order, and the embodiments or the implementations may be arbitrarily combined and may be arbitrarily combined with other embodiments or implementations.

FIG. 3e is a flow chart of a communication control method according to an embodiment of the present disclosure. As shown in FIG. 3e, an embodiment of the present disclosure relates to a communication control method, which is applicable to a terminal 101. The method includes the following steps.

Step 3501, first information is acquired.

In some embodiments, the terminal 101 may receive the first information sent by a network device.

In some embodiments, the first information indicates an association relationship between second information and third information, the second information indicates a configuration of at least one candidate cell, and the third information indicates a manner for processing a first communication entity.

For implementations of step 3501, reference can be made to the implementations of step 2101 of FIG. 2, the implementations of step 3101 of FIG. 3a, the implementations of step 3201 of FIG. 3b, the implementations of step 3301 of FIG. 3c, and the implementations of step 3401 of FIG. 3d, as well as other related parts in the embodiments involved in FIG. 2, which will not be repeated here.

Step 3502, third information is determined based on a protocol agreement.

In some embodiments, a manner for controlling a first communication entity may be stipulated in a protocol agreement or predefined. The terminal may determine the manner for controlling the first communication entity according to the protocol agreement.

For descriptions of the manner for controlling the first communication entity, reference can be made to the embodiments shown in FIG. 2, which will not be repeated here.

Step 3503, a first communication entity is processed based on the third information.

In some embodiments, processing the first communication entity based on third information corresponding to the fourth information includes: when at least the configuration of the second cell belongs to the fifth information, processing the first communication entity based on the third information corresponding to the fifth information.

For implementations of step 3503, reference can be made to the implementations of step 2105 of FIG. 2, the implementations of step 3105 of FIG. 3a, the implementations of step 3206 of FIG. 3b, the implementations of step 3306 of FIG. 3c, the implementations of step 3404 of FIG. 3d, and other related parts in the embodiments involved in FIG. 2, which will not be repeated here.

For detailed descriptions of steps 3501-3503, reference can be made to the above embodiments of FIG. 2, FIG. 3a, FIG. 3b, FIG. 3c, and FIG. 3d.

The communication control method involved in the embodiments of the present disclosure may include at least one of steps 3501 to 3503. For example, step 3501 may be implemented as an independent embodiment, and step 3502 may be implemented as an independent embodiment, which is not limited in the present disclosure.

In the embodiments or the implementations, unless there is any contradiction, each step may be independent, arbitrarily combined or exchanged in order, and the embodiments or implementations may be arbitrarily combined and may be arbitrarily combined with other embodiments or implementations.

FIG. 3f is a flow chart of a communication control method according to an embodiment of the present disclosure. As shown in FIG. 3f, an embodiment of the present disclosure relates to a communication control method, which is applicable to a terminal 101. The method includes:

Step 3601, first information is acquired.

In some embodiments, the terminal 101 may receive the first information sent by a network device.

In some embodiments, the first information indicates an association relationship between second information and third information, the second information indicates a configuration of at least one candidate cell, and the third information indicates a manner for processing a first communication entity.

In some embodiments, the terminal receives fourth information sent by the network device, and determines third information corresponding to the fourth information based on the fourth information and the first information.

In some embodiments, the first information includes fifth information, and the terminal determining the third information corresponding to the fourth information based on the fourth information and the first information includes: the terminal determining whether there is fifth information corresponding to the fourth information based on the first information, where the fifth information indicates a configuration group that has an associated relationship with the third information; and if the fifth information exists, the terminal determining the third information based on the fifth information.

In some embodiments, the terminal determining whether the fifth information corresponding to the fourth information exists based on the first information includes: when the configuration of at least one of the first cell or the second cell belongs to the fifth information, the terminal determines that the fifth information corresponding to the fourth information exists.

In some embodiments, when the configuration of at least one of the first cell or the second cell belongs to the fifth information, the terminal determining that there is the fifth information corresponding to the fourth information includes at least one of: the terminal determining seventh information, where the seventh information is fifth information corresponding to the first cell; or the terminal determining eighth information, where the eighth information is fifth information corresponding to the second cell, where the seventh information and the eighth information are the same or different.

In some embodiments, the terminal processes a first communication entity based on the third information corresponding to the fourth information.

In some embodiments, the terminal processing the first communication entity based on the third information corresponding to the fourth information includes: when at least the configuration of the second cell belongs to the fifth information, processing the first communication entity based on the third information corresponding to the fifth information.

In some embodiments, in the absence of the fifth information, the terminal determines the third information based on a protocol agreement.

In some embodiments, the terminal determining the third information corresponding to the fourth information based on the fourth information and the first information further includes: the terminal receiving sixth information sent by the network device, where the sixth information indicates a mobility usage of the terminal; when the sixth information meets a first condition, the terminal determining the third information corresponding to the fourth information based on the fourth information and the first information.

In some embodiments, the first condition includes at least one of: the terminal performing cell handover based on a signaling of the network device; the terminal performing cell handover in response to meeting a triggering condition configured by the network device or a triggering condition stipulated in a protocol agreement.

In some embodiments, the fifth information includes a configuration group identifier.

In some embodiments, the second information includes at least one of: a configuration identifier of the at least one candidate cell; and a candidate cell identifier.

In some embodiments, the third information includes at least one of: indication information on whether to reset or partially reset an MAC entity; indication information on whether to reestablish an RLC entity; indication information on whether to reestablish a PDCP entity; or indication information on whether to recover a PDCP entity.

For implementations of step 3601, reference can be made to the implementations of step 2101 of FIG. 2, the implementations of step 3101 of FIG. 3a, the implementations of step 3201 of FIG. 3b, the implementations of step 3301 of FIG. 3c, the implementations of step 3401 of FIG. 3d, and the implementations of step 3501 of FIG. 3e, as well as other related parts in the embodiments involved in FIG. 2, which will not be repeated here.

In the embodiments or the implementations, unless there is any contradiction, each step may be independent, arbitrarily combined or exchanged in order, and the embodiments or implementations may be arbitrarily combined and may be arbitrarily combined with other embodiments or implementations.

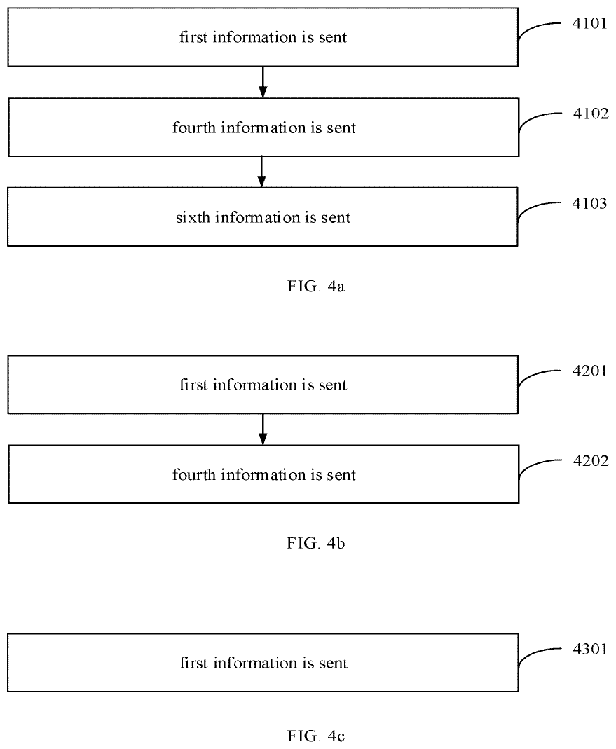

FIG. 4a is a schematic flow chart of a communication control method according to an embodiment of the present disclosure. As shown in FIG. 4a, an embodiment of the present disclosure relates to a communication control method, which is applicable to a network device 102. The method includes the following steps.

Step 4101, first information is sent.

For implementations of step 4101, reference can made to the implementations of step 2101 in FIG. 2 and other related parts in the embodiments involved in FIG. 2, which will not be repeated here.

In some embodiments, the network device 102 may send the first information to a terminal. This is not limited in the present disclosure. The network device 102 may also send the first information to another entity.

In some embodiments, the above-mentioned first information may be used by the terminal 101 to determine the third information. For implementations, refer can be made to the implementations of step 2104 in FIG. 2 and other related parts in the embodiments involved in FIG. 2, which will not be repeated here.

Step 4102, fourth information is sent.

For implementations of step 4102, reference can made to the implementations of step 2102 in FIG. 2 and other related parts in the embodiments involved in FIG. 2, which will not be repeated here.

In some embodiments, the network device 102 may send the fourth information to the terminal. This is not limited in the present disclosure. The network device 102 may also send the fourth information to another entity.

In some embodiments, the fourth information may be used by the terminal 101 to determine the third information. For embodiments, reference can be made to the implementations of step 2104 in FIG. 2 and other related parts in the embodiment involved in FIG. 2, which will not be repeated here.

Step 4103, sixth information is sent.

For implementations of step 4103, reference can made to the implementations of step 2103 in FIG. 2 and other related parts in the embodiments involved in FIG. 2, which will not be repeated here.

In some embodiments, the network device 102 may send the sixth information to a terminal. This is not limited in the present disclosure. The network device 102 may also send the sixth information to another entity.

In some embodiments, the sixth information may be used by the terminal 101 to determine the third information. For embodiments, reference can be made to the implementations of step 2104 in FIG. 2 and other related parts in the embodiments involved in FIG. 2, which will not be repeated here.

The communication control method involved in the embodiments of the present disclosure may include at least one of steps 4101 to 4103. For example, step 4101 may be implemented as an independent embodiment, and step 4103 may be implemented as an independent embodiment. For example, steps 4101+4102 may be implemented as independent embodiments, and steps 4101+4103 may be implemented as independent embodiments, which is not limited in the present disclosure.

In some embodiments, steps 4101, 4102, and 4103 may be performed in an interchanged order or simultaneously.

In some embodiments, step 4101, step 4102, and step 4103 may be performed, and one or more of these steps may be omitted or replaced in different embodiments.

In some embodiments, step 4101 and step 4102 may be performed, and one or more of these steps may be omitted or replaced in different embodiments.

In the embodiments or the implementations, unless there is any contradiction, each step may be independent, arbitrarily combined or exchanged in order, and the embodiments or implementations may be arbitrarily combined and may be arbitrarily combined with other embodiments or implementations.

FIG. 4b is a flow chart of a communication control method according to an embodiment of the present disclosure. As shown in FIG. 4b, an embodiment of the present disclosure relates to a communication control method. The method is applicable to a network device 102. The method includes the following steps.

Step 4201, first information is sent.

For implementations of step 4201, reference can be made to the implementations of step 2101 in FIG. 2, the implementations of step 4101 in FIG. 4a, and other related parts in the embodiments involved in FIG. 2, which will not be repeated here.

Step 4202, fourth information is sent.

In some embodiments, the fourth information is used to assist the terminal in determining third information.

For implementations of step 4202, reference can be made to the implementations of step 2102 of FIG. 2, the implementations of step 4102 of FIG. 4a, and other related parts of the embodiments involved in FIG. 2, which will not be described in detail here.

For detailed descriptions of steps 4201-4202, reference can be made to the embodiments of FIG. 2 above.

The communication control method involved in the embodiments of the present disclosure may include at least one of steps 4201 to 4202. For example, step 4201 may be implemented as an independent embodiment, and step 4202 may be implemented as an independent embodiment, which is not limited in the present disclosure.

In the embodiments or the implementations, unless there is any contradiction, each step may be independent, arbitrarily combined or exchanged in order, and the embodiments or implementations may be arbitrarily combined and may be arbitrarily combined with other embodiments or implementations.

FIG. 4c is a flow chart of a communication control method according to an embodiment of the present disclosure. As shown in FIG. 4c, an embodiment of the present disclosure relates to a communication control method. The method is applicable to a network device 102. The method includes the following steps.

Step 4301, first information is sent.

The first information may be used to assist the terminal in determining third information, so as to implement control of the first communication entity.

For implementations of step 4301, reference can be made to the implementations of step 2101 of FIG. 2, the implementations of step 4101 of FIG. 4a, the implementations of step 4201 of FIG. 4 b, and other related parts of the embodiments involved in FIG. 2, which will not be repeated here.

In the embodiments or the implementations, unless there is any contradiction, each step may be independent, arbitrarily combined or exchanged in order, and the embodiments or implementations may be arbitrarily combined and may be arbitrarily combined with other embodiments or implementations.

In some embodiments, the network device may send fourth information to the terminal, where the fourth information indicates a configuration of a first cell and/or a second cell corresponding to the terminal.

In some embodiments, the first information further includes fifth information, where the fifth information indicates a configuration group having an association relationship with the third information.

In some embodiments, the network device may send sixth information to the terminal, where the sixth information indicates a mobility usage of the terminal.

In some embodiments, the fifth information includes a configuration group identifier.

In some embodiments, the second information includes at least one of:
a configuration identifier of the at least one candidate cell; or a candidate cell identifier.

In some embodiments, the third information includes at least one of:
indication information on whether to reset or partially reset an MAC entity;
indication information on whether to reestablish an RLC entity;
indication information on whether to reestablish a PDCP entity; or
indication information on whether to recover a PDCP entity.

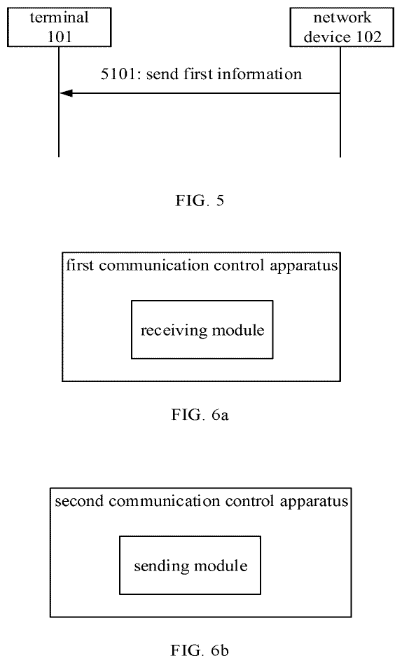

FIG. 5 is a flow chart of a communication control method according to an embodiment of the present disclosure.

As shown in FIG. 5, an embodiment of the present disclosure relates to a communication control method. The method is applicable to a communication system. The method includes the following step.

Step 5101, a network device sends first information to a terminal.

For implementations of step 5101, reference can be made to the implementations of step 2101 in FIG. 2, and other related parts of the embodiments involved in FIG. 2.

In some embodiments, step 5101 may include step 3101 of FIG. 3a and step 4101 of FIG. 4a, as well as implementations of FIGS. 3a-3f, FIGS. 4a-4c, and other related parts in the embodiments involved in FIG. 2, which are not repeated here.

In some embodiments, the above method may include the method described in the above embodiments of the communication system, the above embodiments of the terminal, the above embodiments of the network device, etc., which will not be repeated here.

The following is an example introduction to the above methods.

In some embodiments of the present disclosure, a rule for a layer 2 entity corresponding to a terminal mobility procedure to perform corresponding processing includes at least one of the following rules.

In some embodiments, during the terminal mobility procedure, the layer 2 entity may be processed accordingly according to rule 1.

Rule 1: when the “target candidate cell (or cell group)” or “source cell (or cell group)” belongs to a specific “configuration group” (for example, the target configuration identifier indicated in the L1/L2 signaling belongs to a specific “configuration group”), the terminal performs layer 2 entity processing according to the “layer 2 processing manner configuration” corresponding to the specific “configuration group”.

For example, the source cell cell 1 belongs to configuration group 1, and the layer 2 entity processing manner corresponding to configuration group 1 is resetting anMAC entity. Then, the UE may reset the MAC entity.

In some embodiments, during the terminal mobility procedure, the layer 2 entity may be processed accordingly according to rule 2.

Rule 2: when the “target candidate cell (or cell group)” or “source cell (or cell group)” does not belong to a specific “configuration group”, the terminal performs layer 2 entity processing according to the “layer 2 processing configuration” stipulated in a protocol agreement.

For example, the source cell cell 1 does not belong to any configuration group, and the protocol agreement stipulates resetting an MAC entity, then the UE may reset the MAC entity.

In some embodiments, during the terminal mobility procedure, the layer 2 entity may be processed accordingly according to rule 3.

Rule 3: when the “target candidate cell (or cell group)” and the “source cell (or cell group)” belong to the same “configuration group” (for example, the target configuration identifier indicated in the L1/L2 signaling and the “configuration identifier of the source cell (or cell group)” belong to a specific “configuration group”), the terminal performs layer 2 entity processing according to the “layer 2 processing manner configuration” corresponding to the specific “configuration group” in step 1. (For example, the “source cell (or cell group)” is the service cell (or cell group) before the terminal performs handover (or before the SCG changes), and the “target candidate cell (or cell group)” is the service cell (or cell group) after the terminal performs handover (or after the SCG changes).

For example, the source cell and the target cell both belong to configuration group 1, and the layer 2 entity processing manner corresponding to configuration group 1 is resetting an MAC entity, then the UE may reset the MAC entity.

In some embodiments, during the terminal mobility procedure, the layer 2 entity may be processed accordingly according to rule 4.

Rule 4: when the “target candidate cell (or cell group)” and the “source cell (or cell group)” do not belong to the same “configuration group”, the terminal performs layer 2 entity processing according to the “layer 2 processing configuration” stipulated in a protocol agreement.

In some embodiments, the layer 2 processing configuration may include at least one of:
indication information on whether to reset or partially reset an MAC entity;
indication information on whether to reestablish an RLC entity;
indication information on whether to reestablish a PDCP entity; or indication information on whether to recover a PDCP entity.

It should be understood that the above embodiments may be implemented independently or in combination, which is not limited in the present disclosure.

In some embodiments, the method may include at least one of the following steps.

Step 1: A network provides one or more candidate cell (or cell group) configurations to a terminal (e.g., a candidate cell (or cell group) configuration provided via an RRCReconfiguration message).

The purpose of the “one or more candidate cell (or cell group) configurations” includes at least one of the following usages.

Usage 1: the network may subsequently control the terminal to change among the multiple “candidate cells (or cell groups)” (such as the “dynamic cell (or cell group) change” in the background) via a signaling.

Usage 2: when the terminal meets a triggering condition configured by the network or stipulated in a protocol agreement, the terminal changes the configuration to the candidate cell (or cell group) configuration (for example, when a terminal measurement meets an A3 or A5 event, a serving MCG configuration is changed to a candidate MCG configuration).

Furthermore, the network provides a “layer 2 processing manner configuration of the configuration group” corresponding to the “one or more candidate cell (or cell group) configurations”. The “layer 2 processing configuration of the configuration group” includes at least one of:

Configuration 1: configuration group identification information (e.g., candidateConfigurationSet-1). The “configuration group identification information” may be a network-displayed configuration (e.g., candidateConfigurationSet-ID-1) or an implicit configuration (e.g., numbered according to an order of a configuration group list, with a first item in the configuration group list corresponding to a configuration group identifier “0”).

Configuration 2: identification information corresponding to at least one candidate cell (or cell group). The identification information includes at least one of:
identification information 1: configuration identifier of a candidate cell (or cell group) (e.g., configuration-1). The “configuration identifier of the candidate cell (or cell group)” may adopt a default configuration identifier stipulated in a protocol agreement for the currently serving cell (or cell group) (e.g., a default configuration identifier “0” is adopted, or a current serving MCG configuration corresponds to “0”, or a current serving SCG configuration corresponds to “1”). The “currently serving cell (or cell group)” may be interpreted as at least one of:
Cell 1: a cell (or cell group) that serves the terminal when the terminal first receives the “Layer 2 processing manner configuration of the configuration group”
Cell 2: a cell (or cell group) that serves the terminal when the terminal first receives the “candidate cell (or cell group) configuration”
identification information 2: a candidate cell (or cell group) identifier (e.g., cell-1 or cellGroup-1). The candidate cell group identifier includes the MCG or SCG. The candidate cell identifier includes at least one of:
Cell identifier 1: a Physical Cell Identifier (e.g., PCI-1)
Cell identifier 2: a Cell Global Identifier (e.g., CGI-1)
Cell identifier 3: a Frequency Identifier (e.g., ARFCN (Absolute Radio Frequency Channel Number))

Configuration 3: a Layer 2 processing manner configuration. The “layer 2 processing manner configuration” may be configured through the protocol agreement or the network configuration. The “Layer 2 processing manner configuration” includes at least one of:
Processing configuration 1: indication information on whether to reset (or partially reset) an MAC entity

For example, processing configuration 1 may be resetting the MAC entity, or partially resetting the MAC entity, or not resetting the MAC entity.
Processing configuration 2: indication information on whether to reestablish an RLC entity

For example, processing configuration 2 may be reestablishing the RLC entity. Specifically, whether to reestablish the RLC entity may be determined based on the indication information on whether to reestablish in the RLC configuration.
Processing configuration 3: indication information on whether to reestablish (or recovery) a PDCP entity

For example, processing configuration 2 may be reestablishing the PDCP entity. Specifically, it may be determining whether to reestablish the PDCP entity based on the indication information on whether to reestablish in the PDCP configuration. It may also be recovery of the PDCP entity. Specifically, it may be to determine whether to recover the PDCP entity based on the indication information on whether to recover in the PDCP configuration.

The partial resetting behavior is a partial behavior in a resetting behavior list. (For example, the MAC resetting behavior list includes: treating an uplink timing timer as a timeout; clearing a downlink HARQ buffer; canceling a buffer reporting, etc. The MAC partial resetting is executing the partial behavior in an MAC resetting behavior list, such as retaining an HARQ cache).

Step 2: When the terminal triggers a mobility procedure (e.g., a configuration change of an MCG or SCG), the terminal performs corresponding processing on the layer 2 entity corresponding to the mobility procedure based on the usage of the mobility procedure.

The usage of the mobility procedure is the same as the usage of the at least one candidate cell (or cell group) configured above, that is, usage 1 and usage 2.

The rules for the layer 2 entity corresponding to the terminal mobility procedure to perform corresponding processing include at least one of the following processing rules.

Processing rule 1: when the target candidate cell (or cell group) or the source cell (or cell group) belongs to a specific configuration group (for example, the target configuration identifier indicated in the L1/L2 signaling belongs to the specific configuration group), the terminal performs layer 2 entity processing based on the layer 2 processing manner configuration corresponding to the above-mentioned specific configuration group.

Processing rule 2: when the target candidate cell (or cell group) or the source cell (or cell group) does not belong to a specific configuration group, the terminal performs Layer 2 entity processing based on the Layer 2 processing manner configuration stipulated in a protocol agreement. The layer 2 processing manner configuration stipulated in the protocol agreement may include at least one of the above-mentioned processing configurations 1-3.

Processing rule 3: when the target candidate cell (or cell group) and the source cell (or cell group) belong to the same configuration group (for example, the target configuration identifier indicated in the L1/L2 signaling and the configuration identifier of the source cell (or cell group) belong to the specific configuration group), the terminal performs layer 2 entity processing based on the layer 2 processing manner configuration corresponding to the above-mentioned specific configuration group. (For example, the “source cell (or cell group) is the serving cell (or cell group) before the terminal performs handover (or before the SCG is changed), and the target candidate cell (or cell group) is the serving cell (or cell group) after the terminal performs handover (or after the SCG is changed)).

Processing rule 4: when the target candidate cell (or cell group) and the source cell (or cell group) do not belong to the same configuration group, the terminal performs layer 2 entity processing according to the layer 2 processing manner configuration stipulated in a protocol agreement. The layer 2 processing manner configuration stipulated in the protocol agreement is the same as that of processing rule 2.

The embodiments of the present disclosure further provide an apparatus for implementing any of the above methods. For example, an apparatus is provided, which includes units or modules for implementing each step executed by the terminal in any of the above methods. For another example, another apparatus is proposed, which includes units or modules for implementing the steps performed by the network device (such as an access network device, a core network function nodes, a core network device, etc.) in any of the above methods.

It should be understood that the division of the units or modules in the above apparatus is only a division of logical functions, and in actual implementation, they may be fully or partially integrated into one physical entity, or they may be physically separated. In addition, the units or modules in the apparatus may be implemented in the form of a processor calling software. For example, the apparatus includes a processor, the processor is connected to a memory, instructions are stored in the memory, and the processor calls the instructions stored in the memory to implement any of the above methods or implement the functions of the units or modules of the above-mentioned apparatus. The processor is, for example, a general-purpose processor, such as a central processing unit (CPU) or a microprocessor, and the memory is a memory inside the device or a memory outside the apparatus. Alternatively, the units or modules in the apparatus may be implemented in the form of hardware circuits, and the functions of some or all of the units or modules can be realized by designing the hardware circuits. The above-mentioned hardware circuits may be understood as at least one processor; for example, in one implementation, the above-mentioned hardware circuit is an application-specific integrated circuit (ASIC), and the functions of some or all of the above units or modules are realized by designing the logical relationship of the elements in the circuit. For example, in another implementation, the above-mentioned hardware circuit may be implemented by a programmable logic device (PLD). Taking a field programmable gate array (FPGA) as an example, which may include a large number of logic gate circuits, and the connection relationship between the logic gate circuits is configured by a configuration file, thereby realizing the functions of some or all of the above units or modules. All units or modules of the above apparatus may be implemented entirely by a processor calling software, or entirely by hardware circuits, or partially by a processor calling software and the rest by hardware circuits.

In the embodiments of the present disclosure, the processor is a circuit with signal processing capabilities. In one implementation, the processor may be a circuit with instruction reading and execution capabilities, such as a central processing unit (CPU), a microprocessor, a graphics processing unit (GPU) (which may be understood as a microprocessor), or a digital signal processor (DSP). In another implementation, the processor may implement certain functions through the logical relationship of hardware circuits, and the logical relationship of the above hardware circuits is fixed or reconfigurable. For example, the processor is a hardware circuit implemented by an application-specific integrated circuit (ASIC) or a programmable logic device (PLD), such as an FPGA. In a reconfigurable hardware circuit, the process of the processor loading a configuration document to implement the hardware circuit configuration may be understood as the process of the processor loading instructions to implement the functions of some or all of the above units or modules. In addition, it may also be a hardware circuit designed for artificial intelligence, which can be understood as ASIC, such as a neural network processing unit (NPU), a tensor processing unit (TPU), a deep learning processing unit (DPU), etc.

FIG. 6a is a schematic structural diagram of a first communication control apparatus proposed in an embodiment of the present disclosure.

As shown in FIG. 6a, the first communication control apparatus includes: a receiving module configured to receive first information sent by a network device, where the first information indicates an association relationship between second information and third information, the second information is used to identify a configuration of at least one candidate cell, and the third information is used to identify a manner for controlling a first communication entity. Optionally, the above-mentioned receiving module is configured to execute the steps related to “receiving the first information” performed by the terminal 101 in any of the above methods, which will not be repeated here. Optionally, the first communication control apparatus also includes at least one of: a sending module, a determination module, or a processing module. The sending module is configured to execute the steps related to sending performed by the terminal 101 in any of the above methods, the determination module is used to execute the steps related to determination performed by the terminal 101 in any of the above methods, and the processing module is used to execute the steps related to processing performed by the terminal 101 in any of the above methods, which will not be repeated here.

FIG. 6b is a schematic structural diagram of a second communication control apparatus proposed in an embodiment of the present disclosure. As shown in FIG. 6b, the second communication control apparatus includes: a sending module configured to send first information to the terminal, where the first information indicates an association relationship between second information and third information, the second information indicates a configuration of at least one candidate cell, and the third information indicates a manner for controlling a first communication entity. Optionally, the sending module is configured to execute the steps related to “sending the first information” performed by the network device 102 in any of the above methods, which will not be repeated here.

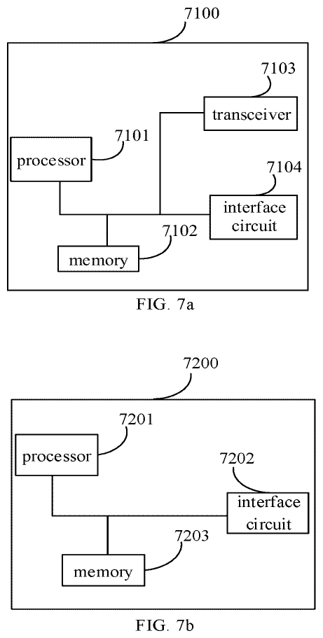

FIG. 7a is a schematic structural diagram of a communication device 7100 proposed in an embodiment of the present disclosure. The communication device 7100 may be a network device (such as an access network device, a core network device, etc.), or a terminal (such as a user device, etc.), or a chip, a chip system, or a processor that supports the network device to implement any of the above methods, or a chip, a chip system, or a processor that supports the terminal to implement any of the above methods. The communication device 7100 may be configured to implement the methods described in the above method embodiments. For details, please refer to the description in the above method embodiments.

As shown in FIG. 7a, the communication device 7100 includes at least one processor 7101. The processor 7101 may be a general-purpose processor or a dedicated processor, for example, a baseband processor or a central processing unit. The baseband processor may be used to process communication protocols and communication data, and the central processing unit can be used to control communication devices (such as base stations, baseband chips, terminal devices, terminal device chips, DU or CU, etc.), execute programs, and process program data. The processor 7101 is configured to call instructions to enable the communication device 7100 to execute any of the above methods.

In some embodiments, the communications device 7100 also includes at least one memory 7102 for storing instructions. Optionally, all or part of the memory 7102 may also be located outside the communication device 7100.

In some embodiments, the communication device 7100 also includes one or more transceivers 7103. When the communication device 7100 includes one or more transceivers 7103, the communication steps such as sending and receiving in the above methods are performed by the transceiver 7103, and the other steps are performed by the processor 7101.

In some embodiments, the transceiver may include a receiver and a transmitter, and the receiver and the transmitter may be separate or integrated. Optionally, terms such as transceiver, transceiver unit, transceiving machine, and transceiver circuit may be replaced with each other, terms such as transmitter, transmitting unit, transmitting machine, and transmitting circuit may be replaced with each other, and terms such as receiver, receiving unit, receiving machine, and receiving circuit may be replaced with each other.

Optionally, the communication device 7100 further includes one or more interface circuits 7104, which are connected to the memory 7102. The interface circuit 7104 may be used to receive signals from the memory 7102 or other devices, and may be used to send signals to the memory 7102 or other devices. For example, the interface circuit 7104 may read instructions stored in the memory 7102 and send the instructions to the processor 7101.

The communication device 7100 described in the above embodiments may be a network device or a terminal, but the scope of the communication device 7100 described in the present disclosure is not limited thereto, and the structure of the communication device 7100 may not be limited to FIG. 7a. The communication device may be a stand-alone device or may be part of a larger device. For example, the communication device may be: (1) an independent integrated circuit IC, or a chip, or a chip system or subsystem; (2) a collection of one or more ICs, in some implementations, the above IC collection may also include a storage component for storing data and programs; (3) an ASIC, such as a modem; (4) a module that may be embedded in other devices; (5) a receiver, a terminal device, an intelligent terminal device, a cellular phone, a wireless device, a handheld device, a mobile unit, a vehicle-mounted device, a network device, a cloud device, an artificial intelligence device, etc. ; and (6) others, etc.

FIG. 7b is a schematic structural diagram of a chip 7200 according to an embodiment of the present disclosure. For a case where the communication device 7100 may be a chip or a chip system, reference can be made to the structural diagram of the chip 7200 shown in FIG. 7b, but the present disclosure is not limited thereto.

The chip 7200 includes at least one processor 7201, and the processor 7201 is configured to call instructions so that the chip 7200 executes any of the above methods.

In some embodiments, the chip 7200 further includes one or more interface circuits 7202, which are connected to the memory 7203. The interface circuit 7202 may be configured to receive signals from the memory 7203 or other devices, and may be used to send signals to the memory 7203 or other devices. For example, the interface circuit 7202 may read instructions stored in the memory 7203 and send the instructions to the processor 7201. Optionally, terms such as interface circuit, interface, transceiver pin, and transceiver may be replaced with each other.

In some embodiments, the chip 7200 also includes at least one memory 7203 for storing instructions. Optionally, all or part of memory 7203 may be outside chip 7200.

The present disclosure also proposes a storage medium having instructions stored thereon. When the instructions are executed on the communication device 7100, the communication device 7100 executes any of the above methods. Optionally, the above storage medium is an electronic storage medium. Optionally, the above storage medium is a computer-readable storage medium, but is not limited thereto, and may also be a storage medium readable by other devices. Optionally, the above-mentioned storage medium may be a non-transitory storage medium, but is not limited to this, and may also be a transient storage medium.

The present disclosure also proposes a program product, which, when executed by the communication device 7100, enables the communication device 7100 to execute any of the above methods. Optionally, the program product is a computer program product.

The present disclosure also proposes a computer program, which, when executed on a computer, causes the computer to perform any one of the above methods.

In the above embodiments, all or part of them may be implemented by software, hardware, firmware or any combination thereof. When implemented using software, all or part of the implementation may be in the form of a computer program product. The computer program product includes one or more computer programs. When the computer program is loaded and executed on a computer, the process or function described in the embodiments of the present disclosure is generated in whole or in part. The computer may be a general purpose computer, a special purpose computer, a computer network, or other programmable device. The computer program may be stored in a computer-readable storage medium or transmitted from one computer-readable storage medium to another computer-readable storage medium. For example, the computer program may be transmitted from one website, computer, server, or data center to another website, computer, server, or data center via wired (e.g., coaxial cable, optical fiber, digital subscriber line (DSL)) or wireless (e.g., infrared, wireless, microwave, etc.) means. The computer-readable storage medium may be any available medium that can be accessed by a computer or a data storage device such as a server or a data center that includes one or more available media. The available medium may be a magnetic medium (e.g., a floppy disk, a hard disk, a magnetic tape), an optical medium (e.g., a high-density digital video disc (DVD)), or a semiconductor medium (e.g., a solid state disk (SSD)).

The correspondence relationships shown in the tables in the present disclosure may be configured or predefined. The values of the information in each table are only examples and may be configured to other values, which are not limited by the present disclosure. When configuring the correspondence relationship between information and parameters, it is not necessarily required to configure all the correspondence relationship illustrated in the tables. For example, in the tables in the present disclosure, the correspondence relationships shown in certain rows may not be configured. For another example, appropriate deformation adjustments may be made based on the above table, such as splitting, merging, etc. The names of the parameters indicated in the titles of the above tables may also be other names understandable to the communication device, and the values or representations of the parameters may also be other values or representations understandable to the communication device. When implementing the above tables, other data structures may also be used, such as arrays, queues, containers, stacks, linear lists, pointers, linked lists, trees, graphs, structures, classes, heaps, hash tables, or the like.

The predefined in the present disclosure may be understood as defined, predefined, stored, pre-stored, pre-negotiated, pre-configured, solidified, or pre-burned.

Those skilled in the art will appreciate that the units and algorithm steps of each example described in conjunction with the embodiments disclosed herein may be implemented by electronic hardware, or a combination of computer software and electronic hardware. Whether these functions are performed in hardware or software depends on the specific application and design constraints of the technical solution. The person skilled in the art may use different methods to implement the described functions for each specific application, but such implementation should not be considered to be beyond the scope of the present disclosure.

Those skilled in the art will clearly understand that, for the convenience and brevity of description, the specific operating processes of the systems, apparatuses and units described above can refer to the corresponding processes in the aforementioned method embodiments and will not be repeated here.

The above descriptions are only specific embodiments of the present disclosure, but the protection scope of the present disclosure is not limited thereto. Any technician familiar with the technical field can easily think of changes or replacements within the technical scope disclosed in the present disclosure, and they should all be covered by the protection scope of the present disclosure. Therefore, the protection scope of the present disclosure should be based on the protection scope of the claims.

1. A communication control method, performed by a terminal, comprising:
receiving first information sent by a network device,
wherein the first information indicates an association relationship between second information and third information, the second information indicates a configuration of at least one candidate cell, and the third information indicates a manner for processing a first communication entity.

2. The method according to claim 1, further comprising:
receiving fourth information sent by the network device, wherein the fourth information indicates a configuration of at least one of a first cell or second cell corresponding to the terminal; and
determining third information corresponding to the fourth information based on the fourth information and the first information.

3. The method according to claim 2, wherein the first information comprises fifth information, and determining the third information corresponding to the fourth information based on the fourth information and the first information comprises:
determining whether fifth information corresponding to the fourth information exists based on the first information, wherein the fifth information indicates a configuration group having an association relationship with the third information; and
determining the third information based on the fifth information in response to the fifth information existing.

4. The method according to claim 3, wherein determining whether the fifth information corresponding to the fourth information exists based on the first information comprises:
determining the fifth information corresponding to the fourth information exists in response to the configuration of at least one of the first cell or the second cell belonging to the fifth information.

5. The method according to claim 4, wherein determining the fifth information corresponding to the fourth information exists in response to the configuration of at least one of the first cell or the second cell belonging to the fifth information comprises at least one of:
determining seventh information, the seventh information being fifth information corresponding to the first cell; or
determining eighth information, the eighth information being fifth information corresponding to the second cell;
wherein the seventh information and the eighth information are the same or different.

6. The method according to claim 3, further comprising:
processing the first communication entity based on the third information corresponding to the fourth information.

7. The method according to claim 6, wherein processing the first communication entity based on the third information corresponding to the fourth information comprises:
processing the first communication entity based on the third information corresponding to the fifth information, in response to at least the configuration of the second cell belonging to the fifth information.

8. The method according to claim 3, further comprising:
determining the third information based on a protocol agreement in response to the fifth information not existing.

9. The method according to claim 3, wherein determining the third information corresponding to the fourth information based on the fourth information and the first information further comprises:
receiving sixth information sent by the network device, wherein the sixth information indicates a mobility usage of the terminal; and
determining the third information corresponding to the fourth information based on the fourth information and the first information, in response to the sixth information meeting a first condition.

10. The method according to claim 9, wherein the first condition comprises at least one of:
the terminal performing cell handover based on a signaling of the network device; or
the terminal performing cell handover in response to meeting a triggering condition configured by the network device or a triggering condition stipulated in a protocol agreement.

11. The method according to claim 3, wherein the fifth information comprises a configuration group identifier.

12. The method according to claim 1, wherein the second information comprises at least one of:
a configuration identifier of the at least one candidate cell; or
an identifier of the at least one candidate cell, or
wherein the third information comprises at least one of:
indication information on whether to reset or partially reset a media access control (MAC) entity;
indication information on whether to re-establish a radio link control (RLC) entity;
indication information on whether to re-establish a packet data convergence protocol (PDCP) entity; or
indication information on whether to recovery a PDCP entity.

13. (canceled)

14. A communication control method, performed by a network device, comprising:
sending first information to a terminal,
wherein the first information indicates an association relationship between second information and third information, the second information indicates a configuration of at least one candidate cell, and the third information indicates a manner for processing a first communication entity.

15. The method according to claim 14, further comprising:
sending fourth information to the terminal, wherein the fourth information indicates a configuration of at least one of a first cell or a second cell corresponding to the terminal.

16. The method according to claim 14, wherein the first information further comprises fifth information, and the fifth information indicates a configuration group having an association relationship with the third information.

17. The method according to claim 14, further comprising:
sending sixth information to the terminal, wherein the sixth information indicates a mobility usage of the terminal.

18. The method according to claim 14, wherein the fifth information comprises a configuration group identifier.

19. The method according to claim 14, wherein the second information comprises at least one of:
a configuration identifier of the at least one candidate cell; or
an identifier of the least one candidate cell, or
wherein the third information comprises at least one of:
indication information on whether to reset or partially reset a media access control (MAC) entity;
indication information on whether to re-establish a radio link control (RLC) entity;
indication information on whether to re-establish a packet data convergence protocol (PDCP) entity; or
indication information on whether to recovery a PDCP entity.

20-22. (canceled)

23. A terminal, comprising:
at least one processor; and
a memory storing instructions executable by the at least one processor,
wherein the at least one processor is configured to:
receive first information sent by a network device,
wherein the first information indicates an association relationship between second information and third information, the second information indicates a configuration of at least one candidate cell, and the third information indicates a manner for processing a first communication entity.

24-25. (canceled)

26. A network device, comprising:
at least one processor; and
a memory storing instructions executable by the at least one processor,
wherein the at least one processor is configured to perform the method according to claim 14.
